(19) United States
(12) Patent Application Publication
(10) Pub. No.: US 2018/0243684 A1
(43) Pub. Date: Aug. 30, 2018

(54) METHOD FOR SEPARATING CARBON DIOXIDE

(71) Applicant: MITSUBISHI CHEMICAL CORPORATION, Tokyo (JP)

(72) Inventors: Kenichi KAWAZUISHI, Yokohama-shi (JP); Masayuki IWAMURA, Yokohama-shi (JP)

(21) Appl. No.: 15/966,417

(22) Filed: Apr. 30, 2018

Related U.S. Application Data
(63) Continuation of application No. PCT/JP2016/081453, filed on Oct. 24, 2016.

(30) Foreign Application Priority Data
Oct. 29, 2015 (JP) 2015-213263

(51) Int. Cl. B01D 53/22; B01D 71/02; C10L 3/10

(52) U.S. Cl. CPC B01D 53/22; C10L 2290/548; C10L 3/104; B01D 71/02

(57) ABSTRACT

The present invention is a method for separating carbon dioxide in which the membrane separation is performed such that a carbon dioxide partial pressure difference ΔP at the final outlet on the carbon dioxide non-permeation side is ⅕ or more of the carbon dioxide partial pressure on the carbon dioxide non-permeation side (P_{X}·X_{CO2}), in a separation membrane system provided with an inorganic separation membrane that is permeated by carbon dioxide preferentially from a mixed gas containing methane and the carbon dioxide, therefore, the driving force that is a partial pressure difference of carbon dioxide between on the carbon dioxide non-permeation side and on the carbon dioxide permeation side is maintained, and further the membrane area of the inorganic separation membrane to be used can be suppressed smaller, the carbon dioxide can be efficiently separated, and the cost is low.

### CROSS REFERENCE TO RELATED APPLICATIONS

The present application is a continuation under 35 U.S.C. § 120 of PCT/JP2016/081453, filed Oct. 24, 2016, which is incorporated herein reference and which claimed priority to Japanese Application No. 2015-213263, filed Oct. 29, 2015, the entire content of which is also incorporated herein by reference. The present application likewise claims priority under 35 U.S.C. § 119 to Japanese Application No. 2015-213263, filed Oct. 29, 2015, the entire content of which is also incorporated herein by reference.

### BACKGROUND OF THE INVENTION

### 1. Field of the Invention

The present invention relates to a method for separating carbon dioxide. More specifically, the present invention relates to a method for separating carbon dioxide, which is performed by a membrane separation using an inorganic separation membrane.

### 2. Description of the Related Art

As to the carbon dioxide (CO₂) contained in a natural gas that includes methane (CH₄) as the main component, for example, in a case where a natural gas is transported by using a pipeline, from the viewpoint of improving the heating value per unit gas volume, preventing the pipeline corrosion, and the like, it is required to recover and remove carbon dioxide from a natural gas. Conventionally, as a recovery method of carbon dioxide, a technique such as a chemical absorption method utilizing an amine absorbent or the like, or a physical adsorption method such as a pressure swing adsorption method (PSA) is used, but the energy consumption accompanying regeneration of an absorbent or an adsorbent is large, and therefore, development of a more highly efficient recovery method has been expected.

On the other hand, a process of carbon dioxide separation from a natural gas using a membrane separation has been known as a technique by which the energy can be saved as compared with a carbon dioxide separation process using an existing absorbent or the like. Further, a separation membrane made of a polymer (hereinafter, also referred to as a “polymer membrane”), which has been used as a separation membrane, has a low separation performance, and has a problem in the chemical resistance and the like, therefore, in recent years, a membrane separation using an inorganic separation membrane, which is capable of performing a continuous operation, has a high separation performance, and is excellent in the chemical resistance, has been performed(for example, see JP 2012-236134 A).

In separating carbon dioxide by a membrane separation using an inorganic separation membrane, in order to efficiently enable permeable components to permeate, a driving force that is a partial pressure difference of carbon dioxide between on the carbon dioxide non-permeation side and on the carbon dioxide permeation side in an inorganic separation membrane is required to be maintained. On the other hand, when a membrane having a high separation performance such as an inorganic separation membrane is used, partial pressure of the carbon dioxide on the carbon dioxide permeation side is increased, and the partial pressure difference between on the carbon dioxide non-permeation side and on the permeation side is decreased when the mixed gas that is a raw material is separated up to in the vicinity of the desired concentration, therefore, the driving force is hardly obtained, and thus there has been a problem that the membrane area to be required is increased. Further, because the polymer membrane used so far has a low separation performance, it is not required to consider the maintenance of the driving force, and the like in the application range of a polymer membrane, and the problem is generated only in a case of the separation by applying an inorganic separation membrane, therefore, the specific investigation has not been made so far, and it is urgently required to take measures for this problem. In addition, as to the membrane separation, there is problem that the cost is high and the like when the membrane area of the inorganic separation membrane is large, therefore, it was has been required to suppress the membrane area as small as possible.

### SUMMARY OF THE INVENTION

The present invention has been made to solve the problems as described above, and to provide a method for separating carbon dioxide in which in separating carbon dioxide from a mixed gas containing methane and the carbon dioxide by a membrane separation using an inorganic separation membrane, the membrane area of the inorganic separation membrane can be suppressed smaller while maintaining the driving force that is a partial pressure difference of carbon dioxide between on the carbon dioxide non-permeation side and on the carbon dioxide permeation side.

According to the present invention, in order to solve the above problems, there is provided a method for separating carbon dioxide, including: separating carbon dioxide from a mixed gas containing methane and the carbon dioxide by a membrane separation, wherein in a case where a carbon dioxide mole fraction at a final outlet on a carbon dioxide non-permeation side is expressed as X_{CO2}, a carbon dioxide mole fraction on a carbon dioxide permeation side corresponding to the final outlet on the carbon dioxide non-permeation side is expressed as Y_{CO2}, carbon dioxide non-permeation side pressure is expressed as P_{X}, and carbon dioxide permeation side pressure is expressed as P_{Y}, in a separation membrane system provided with an inorganic separation membrane that is permeated by the carbon dioxide preferentially from the mixed gas, the carbon dioxide is membrane-separated from the mixed gas such that a carbon dioxide partial pressure difference ΔP expressed by the following Formula (I) at the final outlet on the carbon dioxide non-permeation side is ⅕ or more of a carbon dioxide partial pressure on the carbon dioxide non-permeation side (P_{X}·X_{CO2}).

Mathematical Formula 1

ΔP=P_{X}X_{CO2}−P_{Y}Y_{CO2} (I)

According to the method for separating carbon dioxide of the present invention, the carbon dioxide is membrane-separated such that the carbon dioxide partial pressure difference ΔP is ⅗ or less of the carbon dioxide partial pressure on the carbon dioxide non-permeation side (P_{X}·X_{CO2}).

According to the method for separating carbon dioxide of the present invention, an ideal separation factor α of the inorganic separation membrane being provided to the separation membrane system is expressed by the following Formula (II).

$$\begin{matrix}[ Mathematical Formula 2 ] & \\ \frac{20 ( {P}_{X} - {P}_{Y} ) - 4 {P}_{X} {X}_{CO 2}}{5 {P}_{Y} - 4 {P}_{X} {X}_{CO 2}} ≧ α & ( II )\end{matrix}$$

According to the method for separating carbon dioxide of the present invention, an ideal separation factor α of the inorganic separation membrane being provided to the separation membrane system is expressed by the following Formula (III).

$$\begin{matrix}[ Mathematical Formula 3 ] & \\ \frac{10 ( {P}_{X} - {P}_{Y} ) - 6 {P}_{X} {X}_{CO 2}}{15 {P}_{Y} - 6 {P}_{X} {X}_{CO 2}} ≦ α & ( III )\end{matrix}$$

According to the method for separating carbon dioxide of the present invention, the method is used when carbon dioxide is separated from the mixed gas such that a carbon dioxide mole fraction at the final outlet on the carbon dioxide non-permeation side X_{CO2} is a ratio (P_{Y}/P_{X}) or less of the carbon dioxide permeation side pressure P_{Y} to the carbon dioxide non-permeation side pressure P_{X}.

According to the method for separating carbon dioxide of the present invention, carbon dioxide is separated from the mixed gas in the range of P_{X} from 2.1 to 6.1 [MPaA], in the range of P_{Y} from 0.10 to 0.25 [MPaA], and in the range of X_{CO2} from 0.01 to 0.03.

According to the present invention, a method for separating carbon dioxide is as follows. In a separation membrane system provided with an inorganic separation membrane that is permeated by carbon dioxide preferentially from a mixed gas containing methane and the carbon dioxide, the carbon dioxide is membrane-separated from the mixed gas such that a carbon dioxide partial pressure difference ΔP at the final outlet on the carbon dioxide non-permeation side is ⅕ or more of the carbon dioxide partial pressure on the carbon dioxide non-permeation side (P_{X}·X_{CO2}), therefore, the driving force that is a partial pressure difference of carbon dioxide between on the carbon dioxide non-permeation side and on the carbon dioxide permeation side is maintained, and further the membrane area of the inorganic separation membrane to be used can be suppressed smaller, the carbon dioxide can be efficiently separated, and the cost is low.

### BRIEF DESCRIPTION OF DRAWINGS

FIG. 1 is a diagram showing a separation membrane system;

FIG. 2 is a conceptual diagram showing the change of the carbon dioxide partial pressure difference (ΔP) in a case of membrane-separating carbon dioxide;

FIG. 3 is a conceptual diagram showing the change of the carbon dioxide partial pressure difference (ΔP) in a case of membrane-separating carbon dioxide;

FIG. 4 is a diagram showing one example of the relationship among the carbon dioxide partial pressure difference (ΔP), the membrane area of the inorganic separation membrane, and the methane (CH₄) recovery rate;

FIG. 5 is a diagram showing one example of the relationship among the carbon dioxide partial pressure difference (ΔP), the membrane area of the inorganic separation membrane, and the methane (CH₄) recovery rate;

FIG. 6 is a diagram showing the relationship among the carbon dioxide partial pressure difference (ΔP), the membrane area relative value of the inorganic separation membrane, and the methane (CH₄) recovery rate;

FIG. 7 is a diagram showing the relationship among the carbon dioxide partial pressure difference (ΔP), the membrane area relative value of the inorganic separation membrane, and the methane (CH₄) recovery rate;

FIG. 8 is a diagram showing the relationship among the carbon dioxide partial pressure difference (ΔP), the membrane area relative value of the inorganic separation membrane, and the methane (CH₄) recovery rate;

FIG. 9 is a diagram showing the relationship among the carbon dioxide partial pressure difference (ΔP), the membrane area relative value of the inorganic separation membrane, and the methane (CH₄) recovery rate;

FIG. 10 is a diagram showing the relationship among the carbon dioxide partial pressure difference (ΔP), the membrane area relative value of the inorganic separation membrane, and the methane (CH₄) recovery rate;

FIG. 11 is a diagram showing the relationship among the carbon dioxide partial pressure difference (ΔP), the membrane area relative value of the inorganic separation membrane, and the methane (CH₄) recovery rate;

FIG. 12 is a diagram showing the relationship among the carbon dioxide partial pressure difference (ΔP), the membrane area relative value of the inorganic separation membrane, and the methane (CH₄) recovery rate;

FIG. 13 is a diagram showing the relationship among the carbon dioxide partial pressure difference (ΔP), the membrane area relative value of the inorganic separation membrane, and the methane (CH₄) recovery rate;

FIG. 14 is a diagram showing the relationship among the carbon dioxide partial pressure difference (ΔP), the membrane area relative value of the inorganic separation membrane, and the methane (CH₄) recovery rate;

FIG. 15 is a diagram showing the relationship among the carbon dioxide partial pressure difference (ΔP), the membrane area relative value of the inorganic separation membrane, and the methane (CH₄) recovery rate;

FIG. 16 is a diagram showing the relationship among the carbon dioxide partial pressure difference (ΔP), the membrane area relative value of the inorganic separation membrane, and the methane (CH₄) recovery rate;

FIG. 17 is a diagram showing the relationship among the carbon dioxide partial pressure difference (ΔP), the membrane area relative value of the inorganic separation membrane, and the methane (CH₄) recovery rate;

FIG. 18 is a diagram showing the relationship among the carbon dioxide partial pressure difference (ΔP), the membrane area relative value of the inorganic separation membrane, and the methane (CH₄) recovery rate;

FIG. 19 is a diagram showing the relationship among the carbon dioxide partial pressure difference (ΔP), the membrane area relative value of the inorganic separation membrane, and the methane (CH₄) recovery rate;

FIG. 20 is a diagram showing the relationship among the carbon dioxide partial pressure difference (ΔP), the membrane area relative value of the inorganic separation membrane, and the methane (CH₄) recovery rate;

FIG. 21 is a diagram showing the relationship among the carbon dioxide partial pressure difference (ΔP), the membrane area relative value of the inorganic separation membrane, and the methane (CH₄) recovery rate;

FIG. 22 is a diagram showing the relationship among the carbon dioxide partial pressure difference (ΔP), the membrane area relative value of the inorganic separation membrane, and the methane (CH₄) recovery rate;

FIG. 23 is a diagram showing the relationship among the carbon dioxide partial pressure difference (ΔP), the membrane area relative value of the inorganic separation membrane, and the methane (CH₄) recovery rate;

FIG. 24 is a diagram showing the relationship among the carbon dioxide partial pressure difference (ΔP), the membrane area relative value of the inorganic separation membrane, and the methane (CH₄) recovery rate;

FIG. 25 is a diagram showing the relationship among the carbon dioxide partial pressure difference (ΔP), the membrane area relative value of the inorganic separation membrane, and the methane (CH₄) recovery rate;

FIG. 26 is a diagram showing the relationship among the carbon dioxide partial pressure difference (ΔP), the membrane area relative value of the inorganic separation membrane, and the methane (CH₄) recovery rate;

FIG. 27 is a diagram showing the relationship among the carbon dioxide partial pressure difference (ΔP), the membrane area relative value of the inorganic separation membrane, and the methane (CH₄) recovery rate;

FIG. 28 is a diagram showing the relationship among the carbon dioxide partial pressure difference (ΔP), the membrane area relative value of the inorganic separation membrane, and the methane (CH₄) recovery rate;

FIG. 29 is a diagram showing the relationship among the carbon dioxide partial pressure difference (ΔP), the membrane area relative value of the inorganic separation membrane, and the methane (CH₄) recovery rate;

FIG. 30 is a diagram showing the relationship among the carbon dioxide partial pressure difference (ΔP), the membrane area relative value of the inorganic separation membrane, and the methane (CH₄) recovery rate;

FIG. 31 is a diagram showing the relationship among the carbon dioxide partial pressure difference (ΔP), the membrane area relative value of the inorganic separation membrane, and the methane (CH₄) recovery rate;

FIG. 32 is a diagram showing the relationship among the carbon dioxide partial pressure difference (ΔP), the membrane area relative value of the inorganic separation membrane, and the methane (CH₄) recovery rate;

FIG. 33 is a diagram showing the relationship among the carbon dioxide partial pressure difference (ΔP), the membrane area relative value of the inorganic separation membrane, and the methane (CH₄) recovery rate;

FIG. 34 is a diagram showing the relationship among the carbon dioxide partial pressure difference (ΔP), the membrane area relative value of the inorganic separation membrane, and the methane (CH₄) recovery rate;

FIG. 35 is a diagram showing the relationship among the carbon dioxide partial pressure difference (ΔP), the membrane area relative value of the inorganic separation membrane, and the methane (CH₄) recovery rate;

FIG. 36 is a diagram showing the relationship among the carbon dioxide partial pressure difference (ΔP), the membrane area relative value of the inorganic separation membrane, and the methane (CH₄) recovery rate;

FIG. 37 is a diagram showing the relationship among the carbon dioxide partial pressure difference (ΔP), the membrane area relative value of the inorganic separation membrane, and the methane (CH₄) recovery rate;

FIG. 38 is a diagram showing the relationship among the carbon dioxide partial pressure difference (ΔP), the membrane area relative value of the inorganic separation membrane, and the methane (CH₄) recovery rate;

FIG. 39 is a diagram showing the relationship among the carbon dioxide partial pressure difference (ΔP), the membrane area relative value of the inorganic separation membrane, and the methane (CH₄) recovery rate;

FIG. 40 is a diagram showing the relationship among the carbon dioxide partial pressure difference (ΔP), the membrane area relative value of the inorganic separation membrane, and the methane (CH₄) recovery rate;

FIG. 41 is a diagram showing the relationship among the carbon dioxide partial pressure difference (ΔP), the membrane area relative value of the inorganic separation membrane, and the methane (CH₄) recovery rate;

FIG. 42 is a diagram showing the relationship among the carbon dioxide partial pressure difference (ΔP), the membrane area relative value of the inorganic separation membrane, and the methane (CH₄) recovery rate;

FIG. 43 is a diagram showing the relationship among the carbon dioxide partial pressure difference (ΔP), the membrane area relative value of the inorganic separation membrane, and the methane (CH₄) recovery rate;

FIG. 44 is a diagram showing the relationship among the carbon dioxide partial pressure difference (ΔP), the membrane area relative value of the inorganic separation membrane, and the methane (CH₄) recovery rate;

FIG. 45 is a diagram showing the relationship among the carbon dioxide partial pressure difference (ΔP), the membrane area relative value of the inorganic separation membrane, and the methane (CH₄) recovery rate;

FIG. 46 is a diagram showing the relationship among the carbon dioxide partial pressure difference (ΔP), the membrane area relative value of the inorganic separation membrane, and the methane (CH₄) recovery rate;

FIG. 47 is a diagram showing the relationship among the carbon dioxide partial pressure difference (ΔP), the membrane area relative value of the inorganic separation membrane, and the methane (CH₄) recovery rate;

FIG. 48 is a diagram showing the relationship among the carbon dioxide partial pressure difference (ΔP), the membrane area relative value of the inorganic separation membrane, and the methane (CH₄) recovery rate;

FIG. 49 is a diagram showing the relationship among the carbon dioxide partial pressure difference (ΔP), the membrane area relative value of the inorganic separation membrane, and the methane (CH₄) recovery rate;

FIG. 50 is a diagram showing the relationship among the carbon dioxide partial pressure difference (ΔP), the membrane area relative value of the inorganic separation membrane, and the methane (CH₄) recovery rate;

FIG. 51 is a diagram showing the relationship among the carbon dioxide partial pressure difference (ΔP), the membrane area relative value of the inorganic separation membrane, and the methane (CH₄) recovery rate;

FIG. 52 is a diagram showing the relationship among the carbon dioxide partial pressure difference (ΔP), the membrane area relative value of the inorganic separation membrane, and the methane (CH₄) recovery rate;

FIG. 53 is a diagram showing the relationship among the carbon dioxide partial pressure difference (ΔP), the membrane area relative value of the inorganic separation membrane, and the methane (CH₄) recovery rate;

FIG. 54 is a diagram showing the relationship among the carbon dioxide partial pressure difference (ΔP), the membrane area relative value of the inorganic separation membrane, and the methane (CH₄) recovery rate;

FIG. 55 is a diagram showing the relationship among the carbon dioxide partial pressure difference (ΔP), the membrane area relative value of the inorganic separation membrane, and the methane (CH₄) recovery rate;

FIG. 56 is a diagram showing the relationship among the carbon dioxide partial pressure difference (ΔP), the membrane area relative value of the inorganic separation membrane, and the methane (CH₄) recovery rate;

FIG. 57 is a diagram showing the relationship among the carbon dioxide partial pressure difference (ΔP), the membrane area relative value of the inorganic separation membrane, and the methane (CH₄) recovery rate;

FIG. 58 is a diagram showing the relationship among the carbon dioxide partial pressure difference (ΔP), the membrane area relative value of the inorganic separation membrane, and the methane (CH₄) recovery rate; and

FIG. 59 is a diagram showing the relationship among the carbon dioxide partial pressure difference (ΔP), the membrane area relative value of the inorganic separation membrane, and the methane (CH₄) recovery rate.

### DETAILED DESCRIPTION OF THE INVENTION

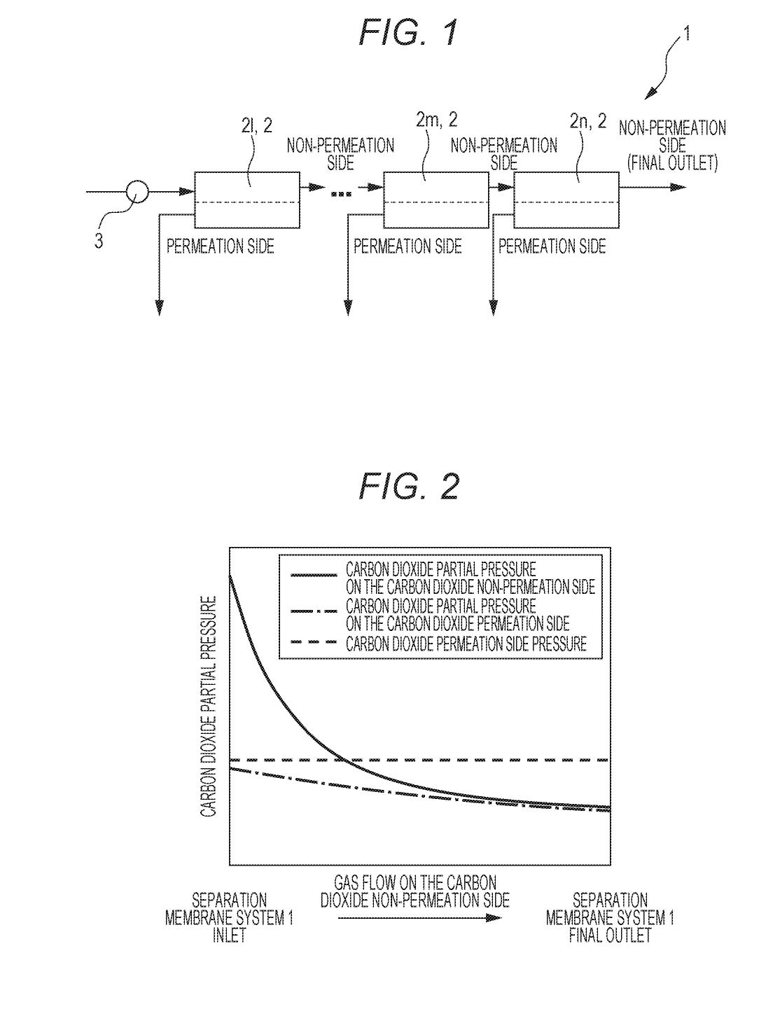

Hereinafter, as to one example of the embodiments of the present invention, a method for separating carbon dioxide according to the present invention will be described by using a separation membrane system 1 shown in FIG. 1. Further, in the equation (for example, Formula (I), and the like) mentioned in the present application, for convenience, the expression “·” (representing multiplying) may be omitted, such that “P_{X}·X_{CO2}” is expressed as “P_{X}X_{CO2}”.

FIG. 1 is a diagram showing a separation membrane system 1 in which a method for separating carbon dioxide according to the present invention is performed. The separation membrane system 1 shown in FIG. 1 shows a system in which an arbitrary number (stage) of single-kind inorganic separation membranes 2, which have an ideal separation factor (described later) common to each other, are arranged. Further, as a contact mode (flow model) of the gas flow on the high pressure side (non-permeation side) and the gas flow on the low pressure side (permeation side) of the separation membrane system 1, there is a case where a counter flow, a concurrently flow, a cross flow, or a combination of these is used, but in the separation method according to the present invention, those flow models can be all applied, and basically a counter flow is used for the explanation in the present embodiment.

The mixed gas to be a raw material, which is subjected to the separation in the present invention, is a mixed gas containing carbon dioxide (CO₂) and methane (CH₄). The inorganic separation membrane 2 used in the separation membrane system 1 is permeated by carbon dioxide preferentially from the above-described mixed gas, and the mixed gas is supplied from an input part 3 to an inorganic separation membrane 2l. The inorganic separation membrane 2l is permeated by carbon dioxide selectively from the mixed gas to be supplied, the carbon dioxide (permeable component) is taken out, and the remaining components (non-permeable components) containing methane as the main component are separated and sent to an inorganic separation membrane 2m. In the same manner, the inorganic separation membrane 2m arranged on the non-permeation side of the inorganic separation membrane 2l is permeated by carbon dioxide selectively from the non-permeable components of the inorganic separation membrane 2l to be supplied, the carbon dioxide (permeable component) is taken out, and the remaining components (non-permeable components) containing methane as the main component are separated and sent to an inorganic separation membrane 2n. For the following inorganic separation membrane 2n, the same operation is performed, and thus carbon dioxide is separated from the mixed gas. Further, the term “non-permeation side” and “permeation side” used in FIG. 1 and the like are terms in consideration of the non-permeation and permeation of the carbon dioxide constituting a mixed gas, and “non-permeation side” means the “carbon dioxide non-permeation side”, and “permeation side” means the “carbon dioxide permeation side”.

In addition, in FIG. 1, for convenience, it has been explained with the arrangement of three inorganic separation membranes 2 (inorganic separation membranes 2l, 2m, and 2n), but the separation membrane system 1 may be configured by one (single stage) inorganic separation membrane 2, or by two or four or more inorganic separation membranes 2. For example, the separation membrane system 1 may be configured by arranging an arbitrary number of inorganic separation membranes 2, which are not shown, between the inorganic separation membrane 2l and the inorganic separation membrane 2m, that is, by containing four or more inorganic separation membranes 2. In the separation membrane system 1 shown in FIG. 1, methane is recovered on the non-permeation side of the inorganic separation membrane 2n, and the non-permeation side of the inorganic separation membrane 2n is the final outlet on the carbon dioxide non-permeation side.

Herein, as described above, the mixed gas, which is a raw material, is a mixed gas containing carbon dioxide (CO₂) and methane (CH₄). Examples of the raw material source of the mixed gas include a natural gas, and a biogas obtained from organic wastes (biomass) or the like, and the present invention can be used as a measure for separating carbon dioxide and taking out methane from the mixed gas.

In the separation membrane system 1 shown in FIG. 1, the inorganic separation membrane 2 is permeated by carbon dioxide preferentially from the mixed gas, and for example, an inorganic separation membrane 2, which is permeated by the carbon dioxide having a kinetic diameter of roughly 0.33 nm (3.3 angstroms) and is not permeated by the methane having a kinetic diameter of roughly 0.38 nm (3.8 angstroms), is preferably used.

As the kind of the inorganic separation membrane 2, it is not particularly limited, and a conventionally known inorganic separation membrane 2 such as a zeolite membrane, a silica membrane, or a carbon membrane, can be used. Among them, as the zeolite membrane, for example, a zeolite membrane such as a CHA (chabazite) type, a SAPO (silicoaluminophosphate) type, a DDR (Deca-Dodecasil 3R) type, a MFI type, or a FAU (faujasite) type can be used.

The configuration (shape, module structure, and the like) of the inorganic separation membrane 2 is not particularly limited, and is appropriately determined by the desired concentration, or the like. Further, the inorganic separation membrane 2 may be used in a form of a multitubular, that is, a so-called separation membrane module, for example, a separation membrane module with a shell & tube type structure in a heat exchanger can be used.

In the present invention, the ideal separation factor α indicates a ratio (α=K_{—CO2}/K_{—CH4}) of the permeance of carbon dioxide (K_{—CO2}) (mol/(m²·Pa·s)) and the permeance of methane (K_{—CH4}) (mol/(m²·Pa·s)) under the performance conditions for an inorganic separation membrane 2. Accordingly, it is indicated that as to the inorganic separation membrane 2, as the ideal separation factor α is larger (the permeance of carbon dioxide per unit permeance of methane is larger), the permeation performance of carbon dioxide is better.

Herein, the carbon dioxide partial pressure difference ΔP is indicated by the difference between the carbon dioxide partial pressure on the carbon dioxide non-permeation side (P_{X}·X_{CO2}) and the carbon dioxide partial pressure on the carbon dioxide permeation side (P_{Y}·Y_{CO2}) in the separation membrane system 1. In Formula (I), ΔP indicates the carbon dioxide partial pressure difference [MPa] at the final outlet on the carbon dioxide non-permeation side, P_{X} indicates the carbon dioxide non-permeation side pressure [MPaA] (substantially common to the pressure on the mixed gas supply side (raw material side), the same applies hereinafter), X_{CO2} indicates the carbon dioxide mole fraction [−] at the final outlet on the carbon dioxide non-permeation side ((hereinafter also simply referred to as the “carbon dioxide mole fraction [−] on the carbon dioxide non-permeation side”), P_{Y} indicates the carbon dioxide permeation side pressure [MPaA], and Y_{CO2} indicates the carbon dioxide mole fraction [−] on the carbon dioxide permeation side corresponding to the final outlet on the carbon dioxide non-permeation side ((hereinafter also simply referred to as “carbon dioxide mole fraction [−] on the carbon dioxide permeation side”). Herein, “the carbon dioxide permeation side corresponding to the final outlet on the carbon dioxide non-permeation side” indicates “the carbon dioxide permeation side which is positioned while sandwiching the inorganic separation membrane 2 to the final outlet on the carbon dioxide non-permeation side, and on which the carbon dioxide mole fraction on the carbon dioxide permeation side Y_{CO2} can be specified”.

[Mathematical Formula 4]

ΔP=P_{X}X_{CO2}−P_{Y}Y_{CO2} (I)

In Formula (I), under the condition that the carbon dioxide partial pressure difference ΔP is extremely small, ΔP≈0, which is approximately equal, therefore, Formula (I) is expressed by Formula (A₁).

[Mathematical Formula 5]

P_{X}X_{CO2}−P_{Y}Y_{CO2}≈0 (A₁)

From the Formula (A₁), the carbon dioxide partial pressure difference ΔP becomes extremely small, and ΔP≈0, which is approximately equal, therefore, the carbon dioxide mole fraction on the carbon dioxide non-permeation side X_{CO2} can be expressed by Formula (A₂).

[Mathematical Formula 6]

X_{CO2}≈P_{Y}Y_{CO2}/P_{X} (A₂)

In a case where an ideal separation factor α indicating a membrane performance of the inorganic separation membrane 2 (permeance ratio of carbon dioxide and methane) is extremely large, the permeation amount of methane is extremely small, and the carbon dioxide mole fraction on the carbon dioxide permeation side is substantially 1.0 (Y_{CO2}≈1.0), therefore, the carbon dioxide mole fraction on the carbon dioxide non-permeation side X_{CO2} becomes the following Formula (A₃).

[Mathematical Formula 7]

X_{CO2}≈P_{Y}/P_{X} (A₃)

From the above, it is considered that in a case where the carbon dioxide partial pressure in the mixed gas to be supplied is lowered until the condition that the mole fraction of carbon dioxide at the final outlet on the carbon dioxide non-permeation side X_{CO2} is a ratio (P_{Y}/P_{X} ) or less of the carbon dioxide permeation side pressure P_{Y} to the carbon dioxide non-permeation side pressure P_{X} is obtained, by the value of the ideal separation factor of the inorganic separation membrane 2, a condition in which the carbon dioxide partial pressure difference that is driving force of a membrane separation is extremely decreased is generated.

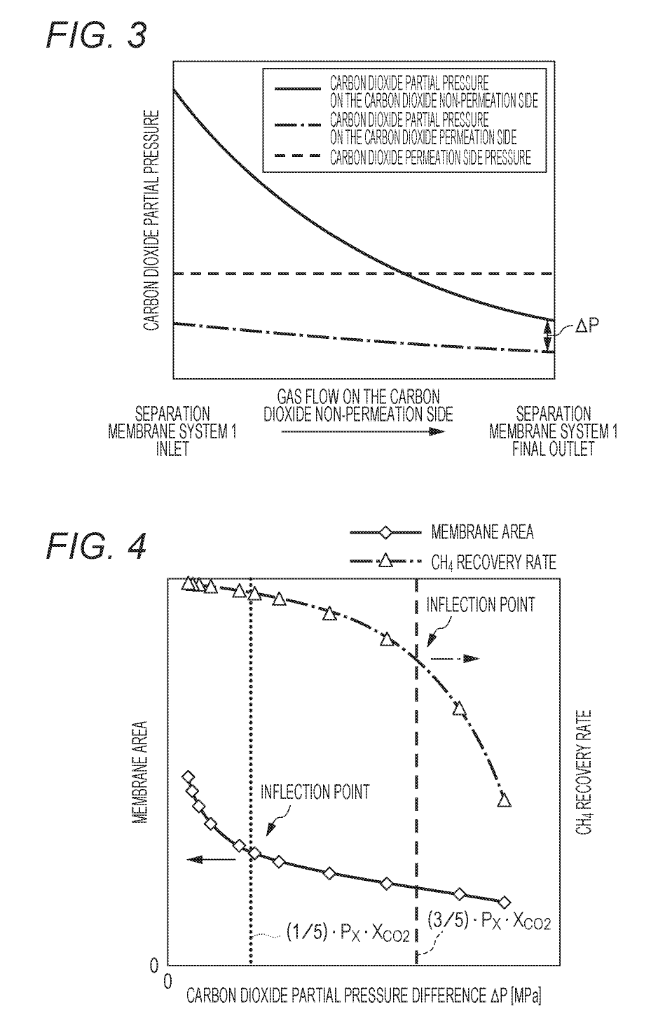

Next, FIG. 2 and FIG. 3 are conceptual diagrams showing the changes of the carbon dioxide partial pressure difference (ΔP) in a case where carbon dioxide is membrane-separated from a carbon dioxide mole fraction (for example, A) to a carbon dioxide mole fraction (for example, B (A>B)) by using the inorganic separation membranes 2 having the same membrane area as each other. In FIG. 2 and FIG. 3, the solid line indicates the carbon dioxide partial pressure on the carbon dioxide non-permeation side P_{X}·X_{CO2}, the dashed-dotted line indicates the carbon dioxide partial pressure on the carbon dioxide permeation side P_{Y}·Y_{CO2}, the dashed line indicates the carbon dioxide permeation side pressure P_{Y} (absolute pressure), the vertical axis indicates the carbon dioxide partial pressure, and the horizontal axis indicates the gas flow on the carbon dioxide non-permeation side (flow direction). Further, the values of ideal separation factor of the inorganic separation membrane 2 to be used is FIG. 2>FIG. 3.

As shown in FIG. 2 and FIG. 3, because the carbon dioxide permeates and is removed through the inorganic separation membrane 2 selectively from a mixed gas to be a raw material, the carbon dioxide partial pressure on the carbon dioxide non-permeation side (solid line) is lowered forming a downward-sloping curve, and corresponding to this, the carbon dioxide partial pressure on the carbon dioxide permeation side (dashed-dotted line) is also lowered forming a downward-sloping curve.

Further, the carbon dioxide permeation side pressure (dashed line) (hereinafter also simply referred to as “permeation side pressure”) in the inorganic separation membrane 2 becomes substantially constant. It is considered that the carbon dioxide permeation side pressure shows almost the same behavior even for an inorganic separation membrane having any value of ideal separation factor irrespective of the ideal separation factor of the inorganic separation membrane 2.

In the separation membrane system 1, a pressure difference is generated between on the carbon dioxide non-permeation side and on the carbon dioxide permeation side of the inorganic separation membrane 2, and by using the pressure difference as the driving force, the carbon dioxide preferentially permeates the inorganic separation membrane 2. In order to efficiently enable permeable components to permeate, it is required that the driving force that is a carbon dioxide partial pressure difference between on the carbon dioxide non-permeation side and on the carbon dioxide permeation side is maintained high (the carbon dioxide partial pressure on the carbon dioxide non-permeation side is higher than that on the carbon dioxide permeation side).

As shown in FIG. 2, when the ideal separation factor is relatively large, methane permeating together with carbon dioxide is relatively little in the inorganic separation membrane 2, therefore, the proportion of the carbon dioxide partial pressure (dashed-dotted line) in the carbon dioxide permeation side pressure (dashed line) is relatively large. Accordingly, the differential pressure ΔP between the carbon dioxide partial pressure at the final outlet on the carbon dioxide non-permeation side (solid line) and the carbon dioxide partial pressure on the carbon dioxide permeation side (dashed-dotted line), which corresponds to the carbon dioxide non-permeation side, of the separation membrane system 1 is relatively small (extremely small in some cases), therefore, there is a case where the driving force required for the membrane separation is hardly obtained. On the other hand, as shown in FIG. 3, when the ideal separation factor is relatively small, methane permeating together with carbon dioxide is relatively much in the inorganic separation membrane 2, therefore, the proportion of the carbon dioxide partial pressure (dashed-dotted line) in the carbon dioxide permeation side pressure (dashed line) is relatively small. Accordingly, the differential pressure ΔP between the carbon dioxide partial pressure at the final outlet on the carbon dioxide non-permeation side (solid line) and the carbon dioxide partial pressure on the carbon dioxide permeation side (dashed-dotted line), which corresponds to the carbon dioxide non-permeation side, of the separation membrane system 1 is relatively large, and the driving force required for the membrane separation is easily obtained.

Further, as shown in FIG. 2, when an inorganic separation membrane 2 having a relatively large ideal separation factor is used, the methane loss is relatively small when the methane is recovered by separating carbon dioxide up to the desired concentration (X_{CO2}) from a mixed gas, and there is an advantage that the methane recovery rate can be increased. On the other hand, as shown in FIG. 3, when an inorganic separation membrane 2 having a relatively small ideal separation factor is used, the membrane area of the inorganic separation membrane 2 is relatively small when carbon dioxide is separated up to the desired concentration (X_{CO2}) from a mixed gas, and there is an advantage that the apparatus is miniaturized and the economic efficiency is easily ensured.

In the present invention, at first, as shown in FIG. 2, it has been found that with taking into account the advantage when an inorganic separation membrane 2 having a relatively large ideal separation factor is used, the proper range in which the membrane area is not excessively large can be arranged based on the driving force even when an inorganic separation membrane 2 having a relatively large ideal separation factor is used. Further, as shown in FIG. 3, it has been found that with taking into account the advantage when an inorganic separation membrane 2 having a relatively small ideal separation factor is used, the proper range in which the methane recovery rate is not excessively small can be arranged based on the driving force in the same manner as in the above even when an inorganic separation membrane 2 having a relatively small ideal separation factor is used.

Further, at the intersection point of the line indicating the carbon dioxide partial pressure on the carbon dioxide non-permeation side with the carbon dioxide permeation side pressure, the carbon dioxide partial pressure on the carbon dioxide non-permeation side (P_{X}·X_{CO2}) and the carbon dioxide permeation side pressure (P_{Y}) become equal to each other (P_{Y}=P_{X}·X_{CO2}), therefore, “X_{CO2}=P_{Y}/P_{X}” is satisfied.

The carbon dioxide partial pressure difference ΔP at the outlet on the carbon dioxide non-permeation side of the separation membrane system 1 is determined by the carbon dioxide partial pressure difference between on the carbon dioxide non-permeation side and on the carbon dioxide permeation side, which is shown in the above-described Formula (I). In the separation method according to the present invention, the membrane separation is performed by the separation membrane system 1 provided with an inorganic separation membrane 2 that is permeated by carbon dioxide preferentially from a mixed gas, such that the carbon dioxide partial pressure difference ΔP expressed by Formula (I) at the final outlet on the carbon dioxide non-permeation side is ⅕ or more of the carbon dioxide partial pressure on the carbon dioxide non-permeation side (P_{X}·X_{CO2}). When the relationship is expressed by equation, the following Formula (II-1) is obtained.

$$\begin{matrix}[ Mathematical Formula 8 ] & \\ {P}_{X} {X}_{CO 2} - {P}_{Y} {Y}_{CO 2} ≧ \frac{1}{5} \cdot {P}_{X} {X}_{CO 2} & ( II \text{-} 1 )\end{matrix}$$

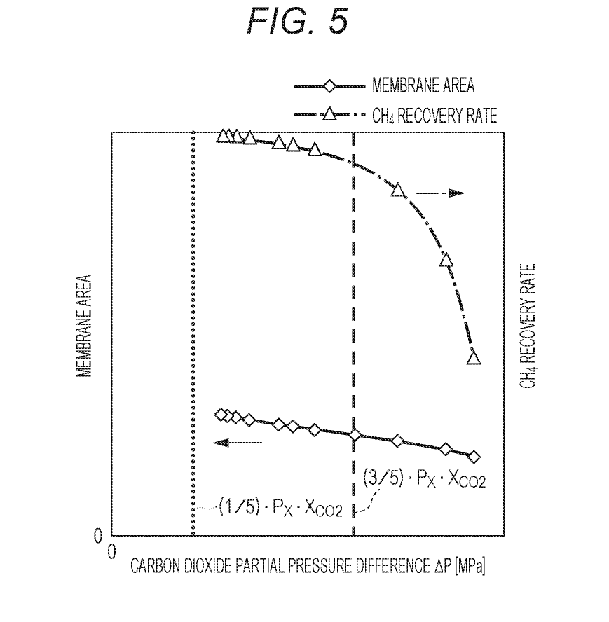

FIG. 4 is a diagram showing one example of the relationship among the carbon dioxide partial pressure difference (ΔP), the membrane area of an inorganic separation membrane, and the methane (CH₄) recovery rate, in a case where carbon dioxide is separated from a mixed gas such that the carbon dioxide mole fraction at the final outlet on the carbon dioxide non-permeation side X_{CO2} is a ratio (P_{Y}/P_{X}) or less of the carbon dioxide permeation side pressure P_{Y} to the carbon dioxide non-permeation side pressure P_{X}. Herein, in FIG. 4, the short dashed line indicates a position of ΔP=(⅕)·P_{X}·X_{CO2}, and the long dashed line indicates a position of ΔP=(⅗)·P_{X}·X_{CO2} (the same applies also in FIG. 5 that is described later). Further, the positions of the short dashed line ((⅕)·P_{X}·X_{CO2}) and the long dashed line ((⅗)·P_{X}·X_{CO2}) in FIG. 4 are determined by obtaining P_{X}·X_{CO2} [MPa] under the conditions to be subjected and calculating from the obtained value.

As to the relationship among the carbon dioxide partial pressure difference ΔP, the membrane area of an inorganic separation membrane 2, and methane (CH₄) recovery rate indicated in FIG. 4, and FIG. 5 that is described later, the permeance of carbon dioxide K_{—CO2} is made constant (for example, 1.0×10⁻⁷ mol/(m²·Pa·s)), and the ideal separation factor a (permeance ratio of carbon dioxide and methane), the carbon dioxide non-permeation side pressure P_{X}, the carbon dioxide permeation side pressure P_{Y}, the carbon dioxide mole fraction in a mixed gas (supply gas carbon dioxide mole fraction) X₀, and the carbon dioxide mole fraction at the final outlet on the carbon dioxide non-permeation side (carbon dioxide mole fraction on the carbon dioxide non-permeation side) X_{CO2} are used as variables.

In addition, the carbon dioxide non-permeation side pressure P_{X}, the carbon dioxide permeation side pressure P_{Y}, and the carbon dioxide mole fraction at the final outlet on the carbon dioxide non-permeation side (carbon dioxide mole fraction on the carbon dioxide non-permeation side) X_{CO2} are used as predetermined conditions, and the carbon dioxide separation from a mixed gas such that the carbon dioxide mole fraction in a mixed gas (supply gas carbon dioxide mole fraction) X₀ becomes an intended mole fraction (X_{CO2}) is calculated (simulated) by using various ideal separation factors α (permeance ratio of carbon dioxide and methane), and further the methane (CH₄) recovery rate is calculated from the methane (CH₄) permeation amount (or the methane (CH₄) amount on the carbon dioxide non-permeation side) in each case. From the above, it is summarized as the relationship to ΔP. Further, it is summarized as the relationship to ΔP by calculating the membrane area required in each case. In the drawing, points (rhombus: ⋄) plotted on the solid line indicating the membrane area and points (triangle: Δ) plotted on the dashed-dotted line indicating the methane recovery rate are points corresponding to individual ideal separation factors α, and as the carbon dioxide partial pressure difference ΔP is smaller, the value corresponding to the larger ideal separation factor α is shown, respectively. Herein, as to ΔP, from the calculation (simulation) results, the value at the final outlet of the inorganic separation membrane 2 is calculated.

The position of ΔP=(⅕)·P_{X}·X_{CO2} shown by the short dashed line in FIG. 4 is an inflection point of the membrane area of the inorganic separation membrane 2, and when ΔP is smaller than ⅕ of the carbon dioxide partial pressure P_{X}·X_{CO2}, it can be confirmed that the membrane area of the inorganic separation membrane 2 rapidly becomes larger. Therefore, by setting ΔP to ⅕ or more of the carbon dioxide partial pressure P_{X}·X_{CO2}, the membrane area of the inorganic separation membrane 2 is suppressed to be relatively small while maintaining the driving force that is a partial pressure difference (ΔP), and the membrane separation can be performed at a low cost.

Further, in the separation method according to the present invention, it is preferred that the membrane separation is performed such that the carbon dioxide partial pressure difference ΔP [MPa] expressed by Formula (I) at the final outlet on the carbon dioxide non-permeation side becomes ⅗ or less of the carbon dioxide partial pressure (P_{X}·X_{CO2}) in the carbon dioxide non-permeation side pressure. When the relationship is expressed by equation, the following Formula (III-1) is obtained.

$$\begin{matrix}[ Mathematical Formula 9 ] & \\ {P}_{X} {X}_{CO 2} - {P}_{Y} {Y}_{CO 2} ≦ \frac{3}{5} \cdot {P}_{X} {X}_{CO 2} & ( III \text{-} 1 )\end{matrix}$$

On the other hand, The position of ΔP=(⅗)·P_{X}·X_{CO2} shown by the long dashed line in FIG. 4 is an inflection point of the methane (CH₄) recovery rate, and when ΔP is larger than ⅗ of the carbon dioxide partial pressure P_{X}·X_{CO2}, it can be confirmed that the recovery rate of methane is rapidly decreased. In this case, it is highly possible that the recovery rate of methane becomes lowered. Therefore, by setting ΔP to ⅗ or less of the carbon dioxide partial pressure P_{X}·X_{CO2}, the methane recovery rate is easily maintained in a relatively high state while maintaining the driving force that is a partial pressure difference (ΔP), accordingly, a technique in which the loss of methane to the permeation side is suppressed, and the recovery rate of methane is high is obtained.

When the relationship described above is summarized, the following Formula (IV-1) is obtained.

$$\begin{matrix}[ Mathematical Formula 10 ] & \\ \frac{1}{5} \cdot {P}_{X} {X}_{CO 2} ≦ {P}_{X} {X}_{CO 2} - {P}_{Y} {Y}_{CO 2} ≦ \frac{3}{5} \cdot {P}_{X} {X}_{CO 2} & ( IV \text{-} 1 )\end{matrix}$$

On the other hand, FIG. 5 is a diagram showing one example of the relationship among the carbon dioxide partial pressure difference (ΔP), the membrane area of an inorganic separation membrane, and the methane (CH₄) recovery rate in a case where carbon dioxide is separated from a mixed gas such that the carbon dioxide mole fraction at the final outlet on the carbon dioxide non-permeation side X_{CO2} is larger than the ratio (P_{Y}/P_{X}) of the carbon dioxide permeation side pressure P_{Y} to the carbon dioxide non-permeation side pressure P_{X} (X_{CO2}>(P_{Y}/P_{X})).

In a case of X_{CO2}>(P_{Y}/P_{X}), the large or small of the driving force does not become problematic when the inorganic separation membrane 2 having relatively large ideal separation factor is used, therefore, in the present embodiment, it is preferred to be applied in a case where the carbon dioxide mole fraction at the final outlet on the carbon dioxide non-permeation side X_{CO2} is a ratio (P_{Y}/P_{X}) or less of the carbon dioxide permeation side pressure P_{Y} to the carbon dioxide non-permeation side pressure P_{X} (X_{CO2}≤(P_{Y}/P_{X})).

Further, in the membrane separation of the separation method according to the present invention, in order to perform the membrane separation such that the carbon dioxide partial pressure difference ΔP is ⅕ or more of the carbon dioxide partial pressure on the carbon dioxide non-permeation side P_{X}·X_{CO2}, the ideal separation factor α of the inorganic separation membrane 2 to be used is preferably expressed by the following Formula (II). In Formula (II), α indicates the ideal separation factor of the inorganic separation membrane 2, P_{X} indicates the carbon dioxide non-permeation side pressure [MPaA], X_{CO2} indicates the carbon dioxide mole fraction [−] at the final outlet on the carbon dioxide non-permeation side, P_{Y} indicates the carbon dioxide permeation side pressure [MPaA], and Y_{CO2} indicates the carbon dioxide mole fraction [−] on the carbon dioxide permeation side.

$$\begin{matrix}[ Mathematical Formula 11 ] & \\ \frac{20 ( {P}_{X} - {P}_{Y} ) - 4 {P}_{X} {X}_{CO 2}}{5 {P}_{Y} - 4 {P}_{X} {X}_{CO 2}} ≧ α & ( II )\end{matrix}$$

In the same manner, in the membrane separation of the separation method according to the present invention, in order that the carbon dioxide partial pressure difference ΔP is ⅗ or less of the carbon dioxide partial pressure on the carbon dioxide non-permeation side P_{X}·X_{CO2}, the ideal separation factor α of the inorganic separation membrane 2 to be used is preferably expressed by the following Formula (III). In Formula (III), α, P_{X}, X_{CO2}, and P_{Y} are common to those in the above-described Formula (II).

$$\begin{matrix}[ Mathematical Formula 12 ] & \\ \frac{10 ( {P}_{X} - {P}_{Y} ) - 6 {P}_{X} {X}_{CO 2}}{15 {P}_{Y} - 6 {P}_{X} {X}_{CO 2}} ≦ α & ( III )\end{matrix}$$

The specifications of the calculation of Formula (II) and Formula (III) are as follows. Firstly, as to the membrane performance of the inorganic separation membrane 2, when the permeance of carbon dioxide is K_{CO2}, and the permeance of methane is K_{CH4} (both unit are [mol/m²·s·Pa]), the ideal separation factors α=K_{CO2}/K_{CH4}, therefore, the following Formula (B₁) is obtained.

[Mathematical Formula 13]

K_{CH4}=K_{CO2}/α (B₁)

As to the supply side, when the carbon dioxide mole fraction on the supply side is X_{CO2} [−], the methane mole fraction on the supply side is X_{CH4} [−], and carbon dioxide and methane are the main components, the relationship between X_{CO2} and X_{CH4} is the following Formula (B₂).

[Mathematical Formula 14]

X_{CO2}+X_{CH4}=1 (B₂)

As to the permeation side, in the same manner as in the above, when the carbon dioxide mole fraction on the permeation side is Y_{CO2} [−], the methane mole fraction on the permeation side is Y_{CH4} [−], and carbon dioxide and methane are the main components, the relationship between Y_{CO2} and Y_{CH4} is the following Formula (B₃).

[Mathematical Formula 15]

Y_{CO2}+Y_{CH4}=1 (B₃)

As to the gas permeation amount, when the carbon dioxide non-permeation side pressure (supply side pressure) is P_{X} and the carbon dioxide permeation side pressure is P_{Y} (both are absolute pressure, and both units are MPaA), the permeation amount of carbon dioxide gas is T_{CO2} and the permeation amount of methane is T_{CH4} (both units are [mol/s]) in the inorganic separation membrane 2 in the separation membrane system 1, and the membrane area of the separation membrane is A [m²], the permeation amount of carbon dioxide gas T_{CO2} is expressed by the following Formula (B₄) and the permeation amount of methane gas T_{CH4} is expressed by the following Formula (B₅) (both units are [mol/s]).

[Mathematical Formula 16]

T_{CO2}=K_{CO2}A(P_{X}X_{CO2}−P_{Y}Y_{CO2}) (B₄)

[Mathematical Formula 17]

T_{CH4}=K_{CH4}A(P_{X}X_{CH4}−P_{Y}Y_{CH4}) (B₅)

Herein, the composition ratio of carbon dioxide gas and methane gas on the carbon dioxide permeation side at the final outlet (supply gas outlet) on the carbon dioxide non-permeation side, and the permeation amount of carbon dioxide gas and methane gas, which are equal to each other, accordingly the following Formula (B₆) is derived.

[Mathematical Formula 18]

Y_{CO2}/Y_{CH4}=T_{CO2}/T_{CH4} (B₆)

In addition, by assigning Formula (B₁), Formula (B₂), Formula (B₃), Formula (B₄), and Formula (B₅) to Formula (B₆), and by organizing for Y_{CO2}, the following Formula (B₇) is obtained.

$$\begin{matrix}[ Mathematical Formula 19 ] & \\ {Y}_{CO 2} = \frac{α ( {P}_{X} {X}_{CO 2} - {P}_{Y} {Y}_{CO 2} )}{( α - 1 ) ( {P}_{X} {X}_{CO 2} - {P}_{Y} {Y}_{CO 2} ) + ( {P}_{X} - {P}_{Y} )} & ( {B}_{7} )\end{matrix}$$

Further, the above-described Formula (II-1) is developed to obtain Formula (II-2), and the following Formula (B₈) is obtained from the Formula (II-2) and the above-described Formula (B₇).

$$\begin{matrix}[ Mathematical Formula 20 ] & \\ {Y}_{CO 2} ≦ \frac{4}{5} \cdot \frac{{P}_{X}}{{P}_{Y}} \cdot {X}_{CO 2} & ( II \text{-} 2 ) \\ [ Mathematical Formula 21 ] & \\ \frac{α ( {P}_{X} {X}_{CO 2} - {P}_{Y} {Y}_{CO 2} )}{( α - 1 ) ( {P}_{X} {X}_{CO 2} - {P}_{Y} {Y}_{CO 2} ) + ( {P}_{X} - {P}_{Y} )} ≦ \frac{4}{5} \cdot \frac{{P}_{X}}{{P}_{Y}} \cdot {X}_{CO 2} & ( {B}_{8} )\end{matrix}$$

Further, by assigning Formula (II-1) to the Formula (B₈), and by organizing in relation to the ideal separation factor α, the following Formula (II) is obtained.

In the same manner, the above-described Formula (III-1) is developed to obtain Formula (III-2), and the following Formula (B₉) is obtained from the (III-2) and the above-described Formula (B₇).

$$\begin{matrix}[ Mathematical Formula 22 ] & \\ {Y}_{CO 2} ≧ \frac{2}{5} \cdot \frac{{P}_{X}}{{P}_{Y}} \cdot {X}_{CO 2} & ( III \text{-} 2 ) \\ [ Mathematical Formula 23 ] & \\ \frac{α ( {P}_{X} {X}_{CO 2} - {P}_{Y} {Y}_{CO 2} )}{( α - 1 ) ( {P}_{X} {X}_{CO 2} - {P}_{Y} {Y}_{CO 2} ) + ( {P}_{X} - {P}_{Y} )} ≧ \frac{2}{5} \cdot \frac{{P}_{X}}{{P}_{Y}} \cdot {X}_{CO 2} & ( {B}_{9} )\end{matrix}$$

In addition, by assigning Formula (III-1) to the Formula (B₉), and by organizing in relation to the ideal separation factor α, the following Formula (III) is obtained.

In addition, when the above-described Formula (II) and Formula (III) are summarized for α, the following Formula (IV) is obtained.

$$\begin{matrix}[ Mathematical Formula 24 ] & \\ \frac{10 ( {P}_{X} - {P}_{Y} ) - 6 {P}_{X} {X}_{CO 2}}{15 {P}_{Y} - 6 {P}_{X} {X}_{CO 2}} ≦ α ≦ \frac{20 ( {P}_{X} - {P}_{Y} ) - 4 {P}_{X} {X}_{CO 2}}{5 {P}_{Y} - 4 {P}_{X} {X}_{CO 2}} & ( IV )\end{matrix}$$

Next, the relationship shown in FIG. 4 and FIG. 5 will be explained by describing about the evaluation results (corresponding also to Examples). The evaluation is performed as follows. In a single-stage separation membrane system 1, the permeance of carbon dioxide (K_{CO2}) in the inorganic separation membrane 2 is used as a fixed value (1.0×10⁻⁷ mol/(m²·Pa·s)), and the total of five parameters, the ideal separation factor α (permeance ratio of carbon dioxide and methane), the carbon dioxide non-permeation side pressure P_{X}, the carbon dioxide permeation side pressure P_{Y}, the supply gas carbon dioxide mole fraction X₀, and the carbon dioxide mole fraction at the final outlet on the carbon dioxide non-permeation side (carbon dioxide mole fraction on the carbon dioxide non-permeation side) X_{CO2} are changed, and the calculation (simulation) is performed. On the basis of the calculation (simulation) results, the relationship among the carbon dioxide partial pressure difference ΔP [MPa] corresponding to the final outlet on the carbon dioxide non-permeation side, the membrane area relative value of an inorganic separation membrane 2, and the methane (CH₄) recovery rate is confirmed. The specific numerical values of the above-described five parameters are as follows.

### (Conditions)

Ideal separation factor α: 5, 10, 25, 50, 100, 150, 200, 400, 600, 800, and 1000 (11 kinds from 5 to 1000)

Carbon dioxide non-permeation side pressure P_{X} [MPaA]: 2.1, 4.1, and 6.1 (3 kinds from 2.1 to 6.1 MPaA)

Carbon dioxide permeation side pressure P_{Y} [MPaA]: 0.10, 0.15, 0.20, and 0.25 (4 kinds from 0.10 to 0.25 MPaA)

Supply gas carbon dioxide mole fraction X₀ [−]: 0.10, 0.20, and 0.40 (3 kinds from 0.10 to 0.40)

Carbon dioxide mole fraction at the final outlet on the carbon dioxide non-permeation side (carbon dioxide mole fraction on the carbon dioxide non-permeation side) X_{CO2} [−]: 0.01, 0.02, and 0.03 (3 kinds from 0.01 to 0.03)

In addition, in the same manner as in FIG. 4 and the like, the carbon dioxide non-permeation side pressure P_{X}, the carbon dioxide permeation side pressure P_{Y}, the carbon dioxide mole fraction at the final outlet on the carbon dioxide non-permeation side (carbon dioxide mole fraction on the carbon dioxide non-permeation side) X_{CO2} are used as predetermined conditions, and the carbon dioxide separation from a mixed gas such that the carbon dioxide mole fraction in a mixed gas (supply gas carbon dioxide mole fraction) X₀ becomes a mole fraction (X_{CO2}) at the desired concentration is calculated (simulated) by using various ideal separation factors α (permeance ratio of carbon dioxide and methane). The methane (CH₄) recovery rate is calculated from the methane (CH₄) permeation amount (or the methane (CH₄) amount on the carbon dioxide non-permeation side) in each case, and the relationship to ΔP is determined. Further, the membrane area required in each case is calculated, and the relationship to ΔP is determined. Furthermore, the membrane area is determined as a relative value (membrane area relative value) using the membrane area in the predetermined ideal separation factor as 1.

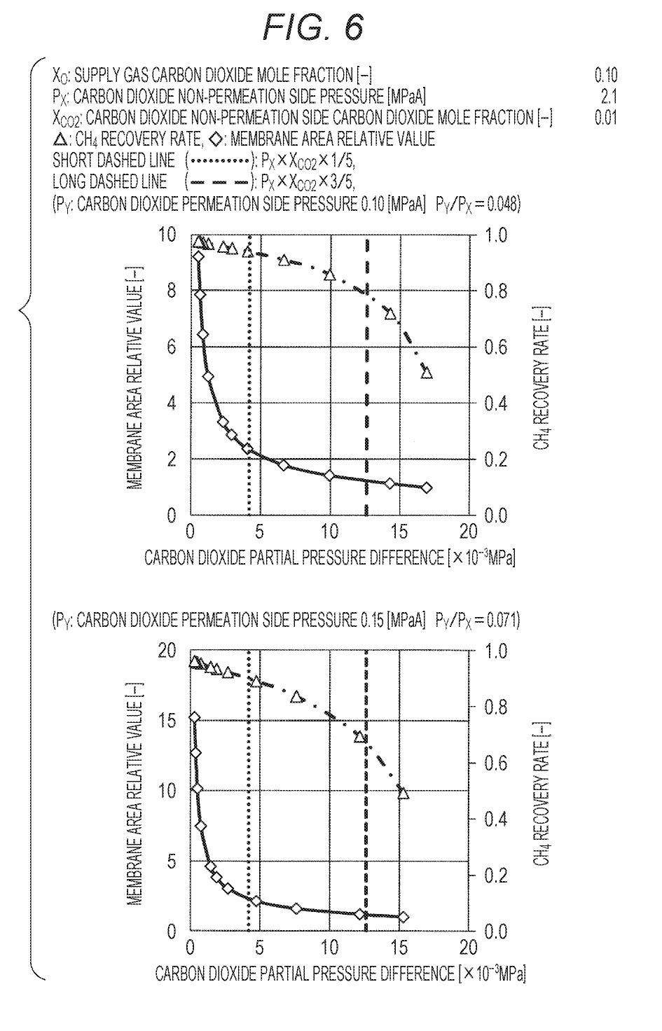

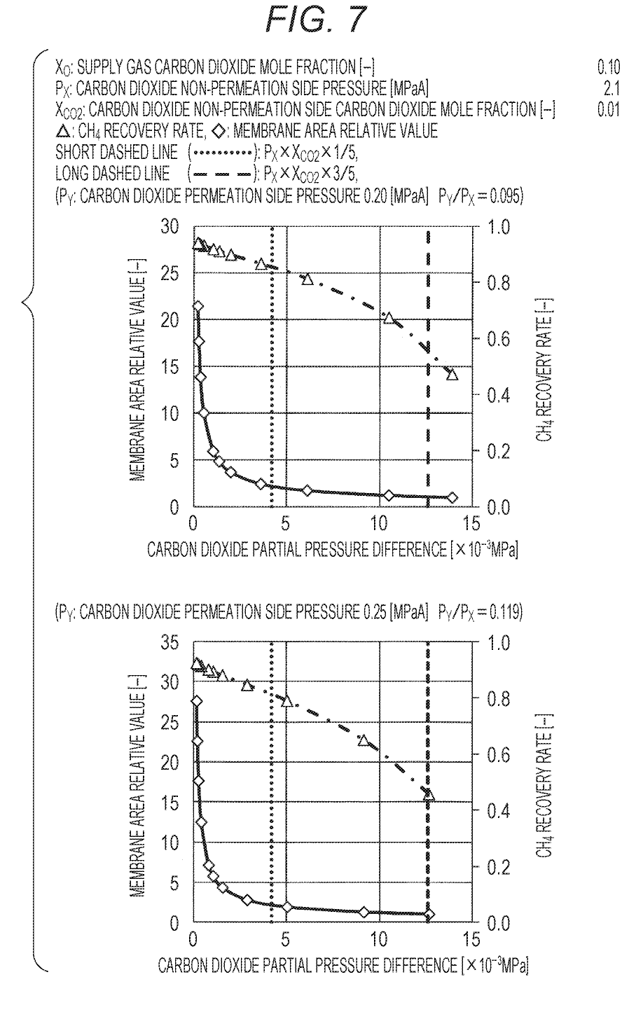

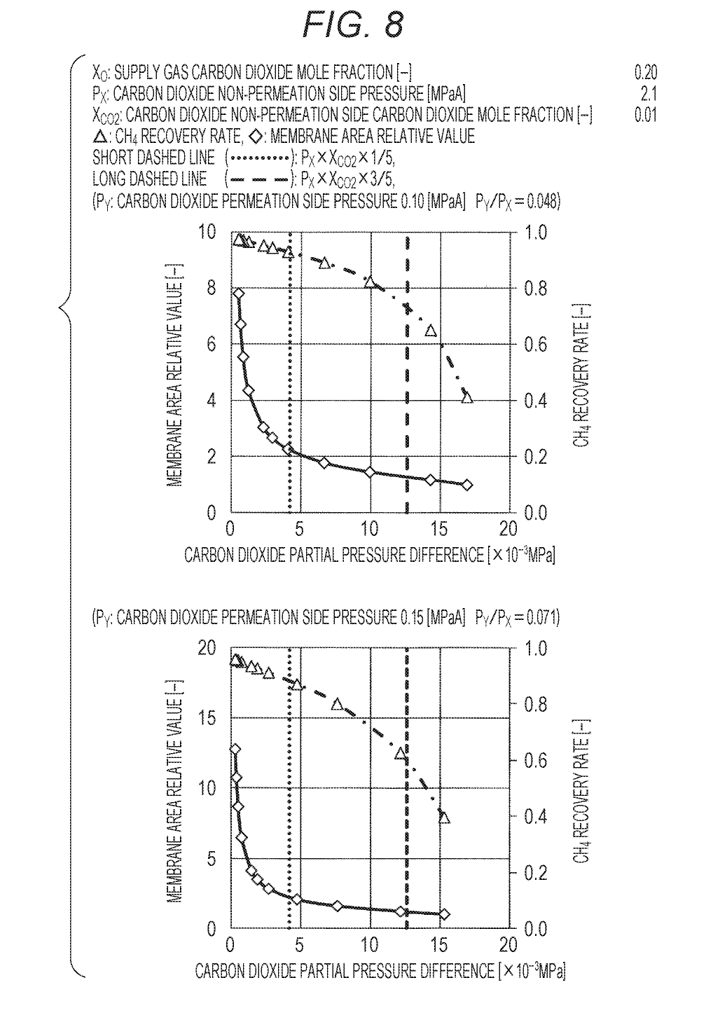

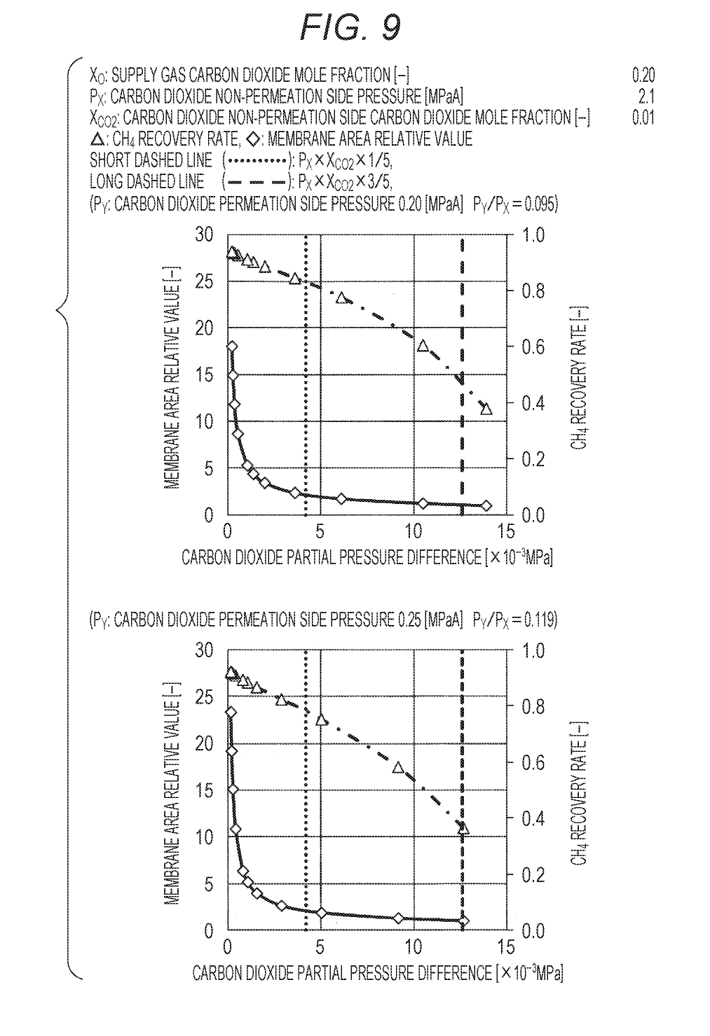

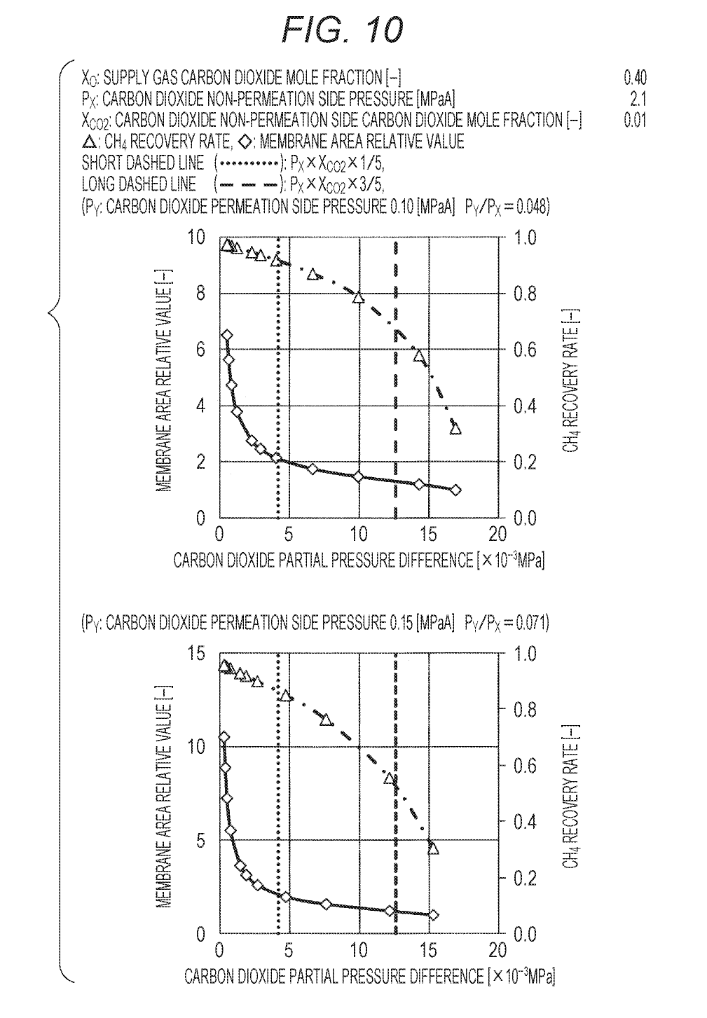

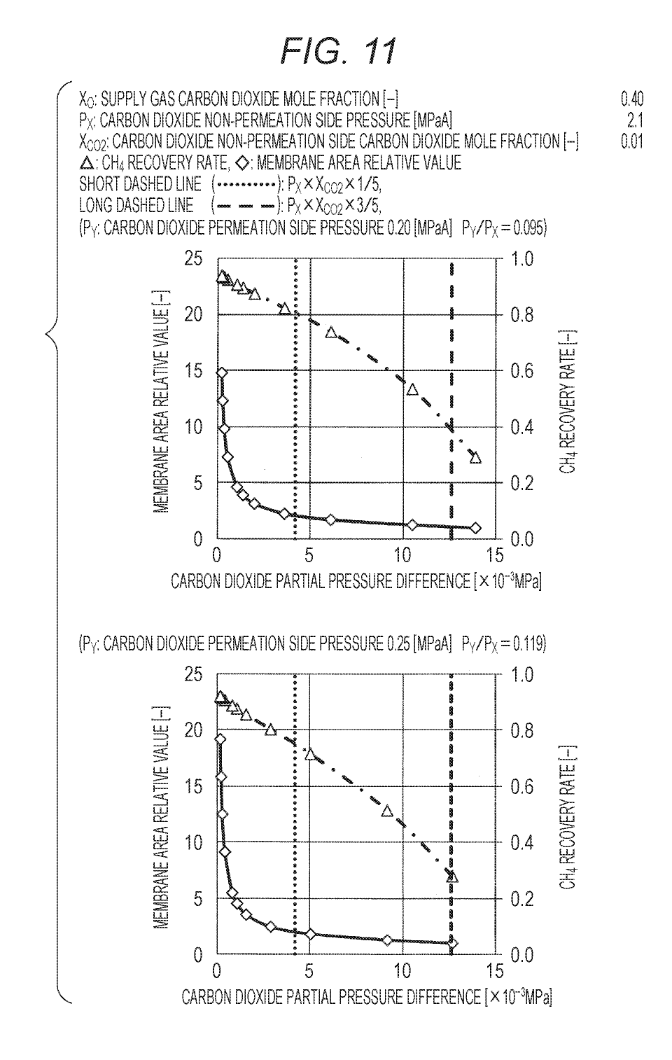

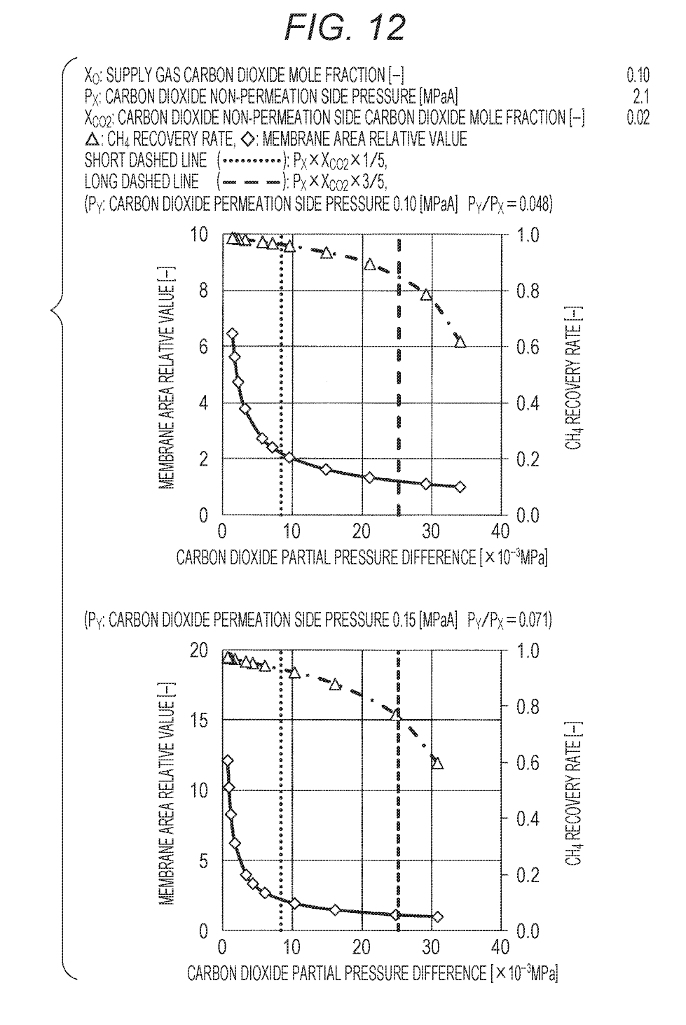

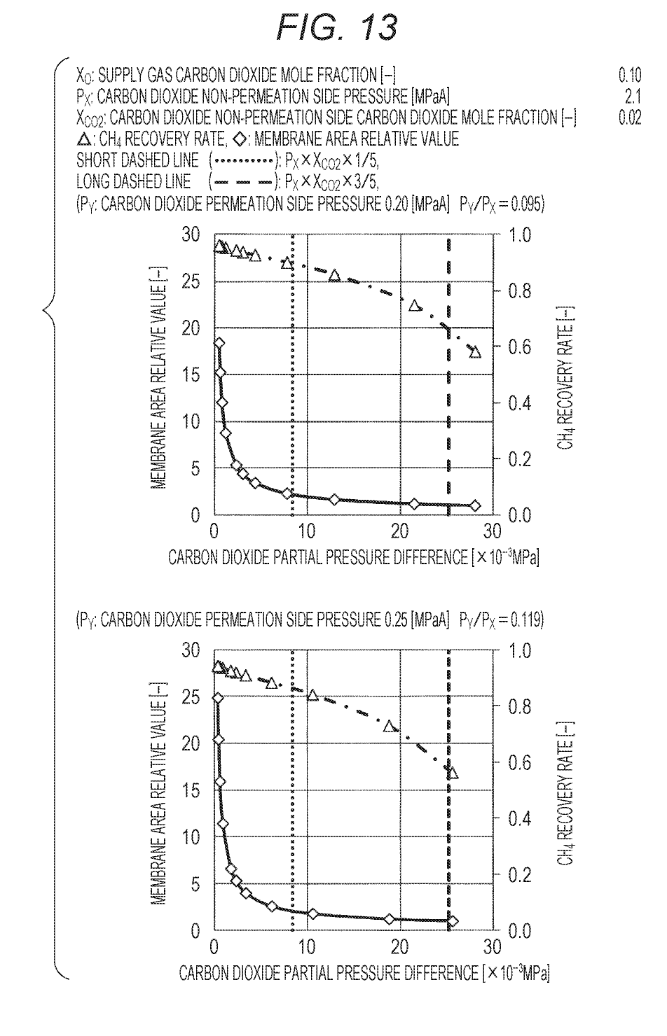

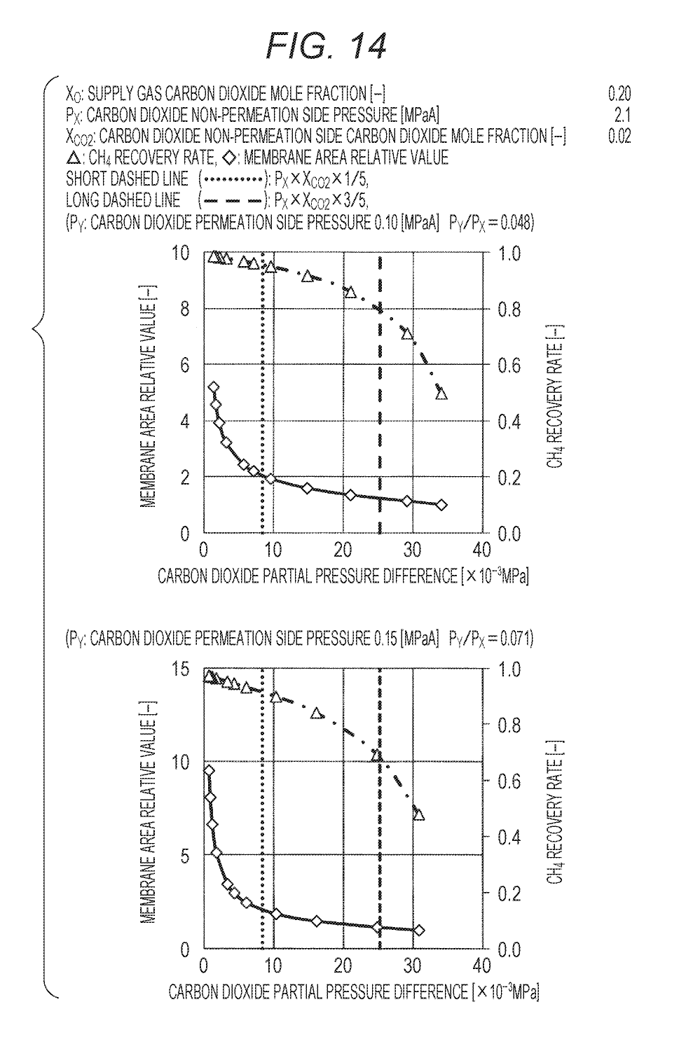

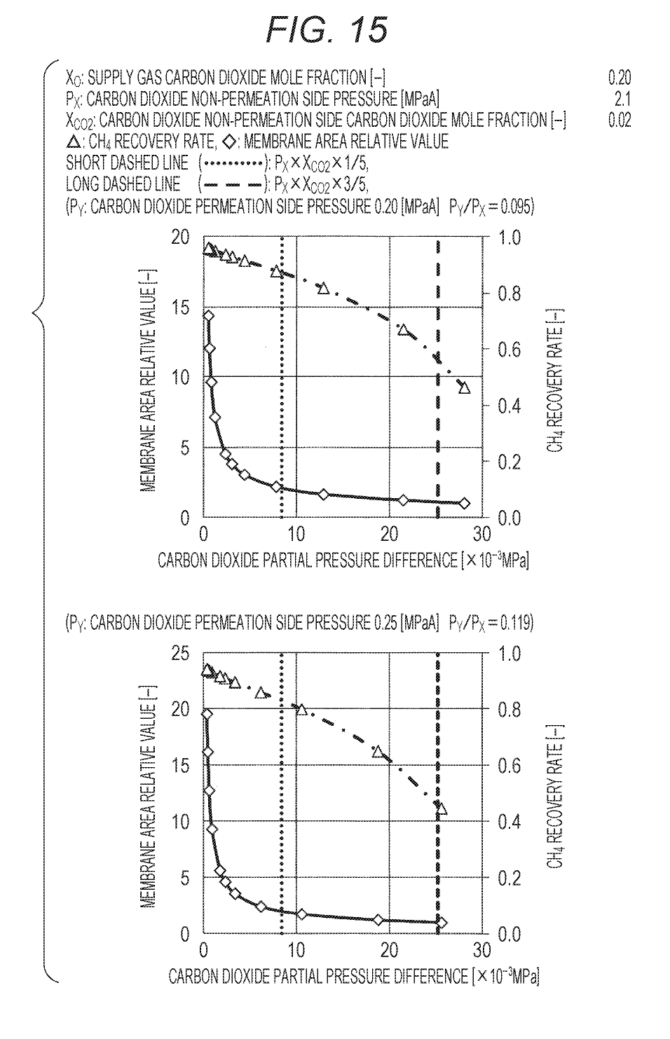

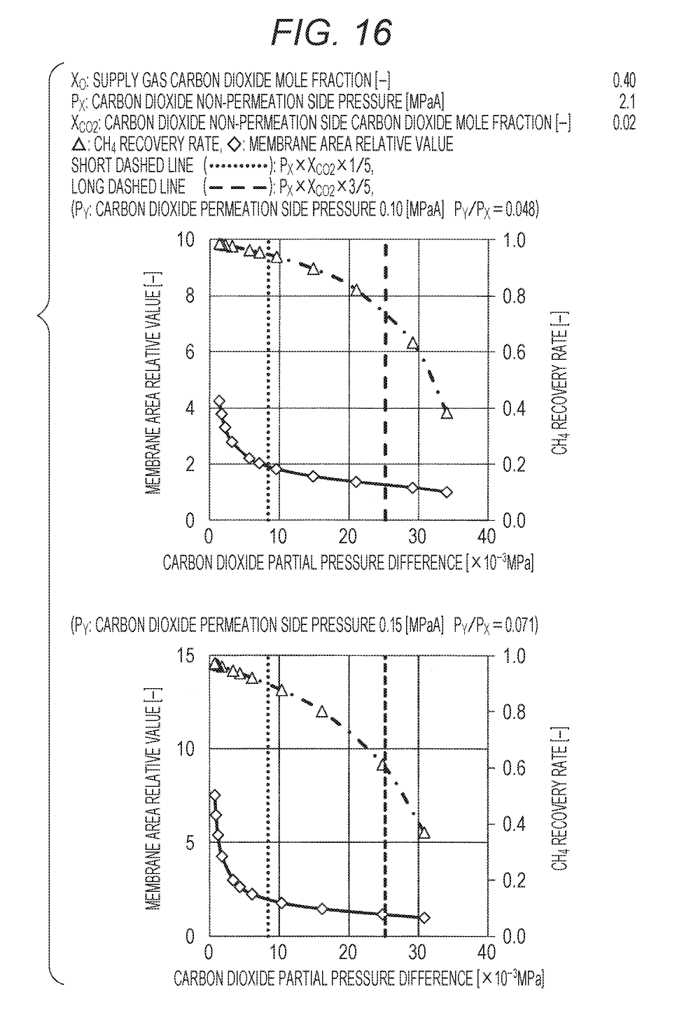

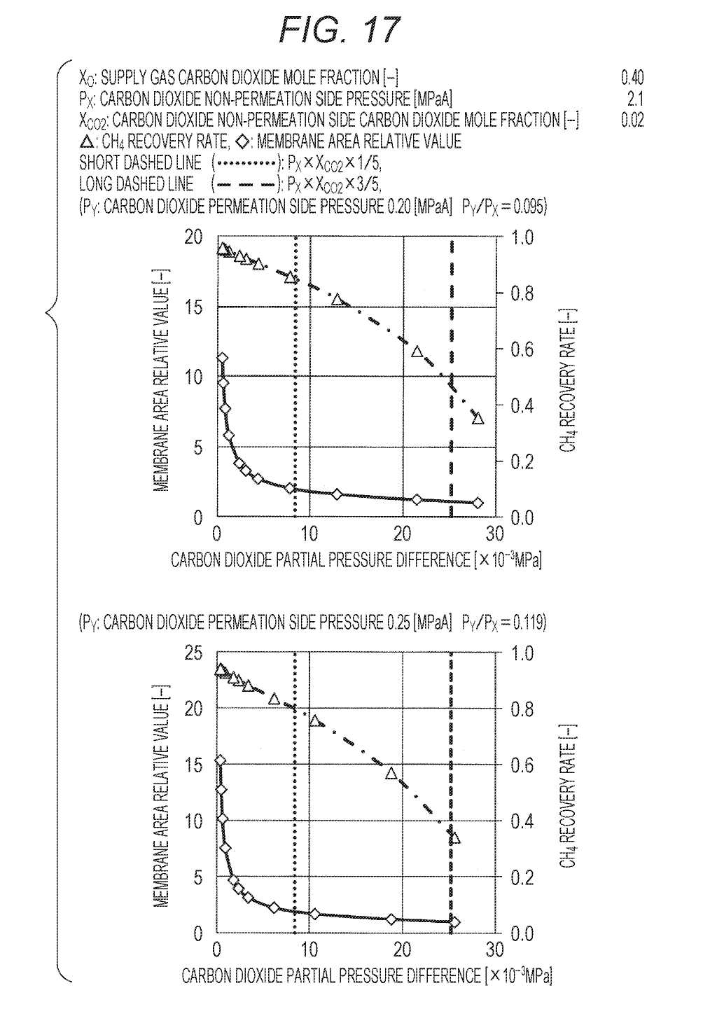

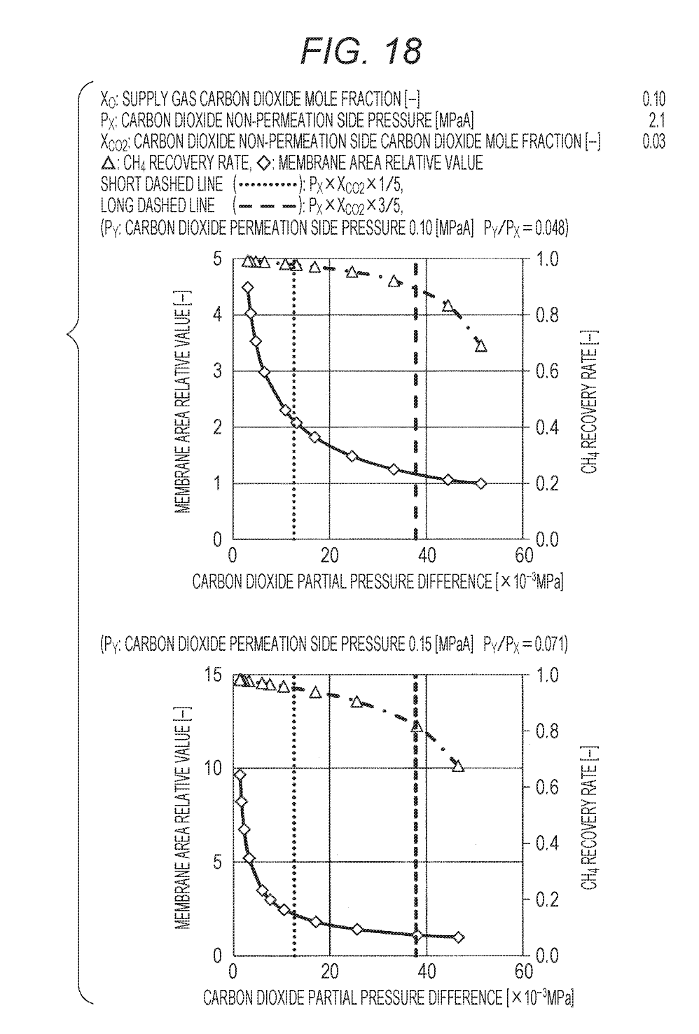

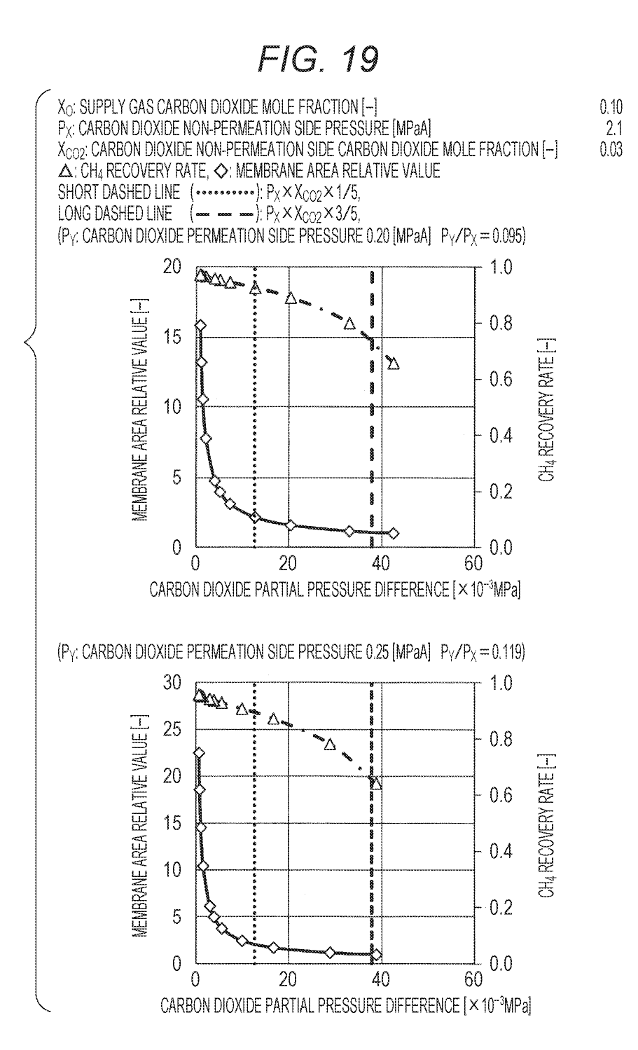

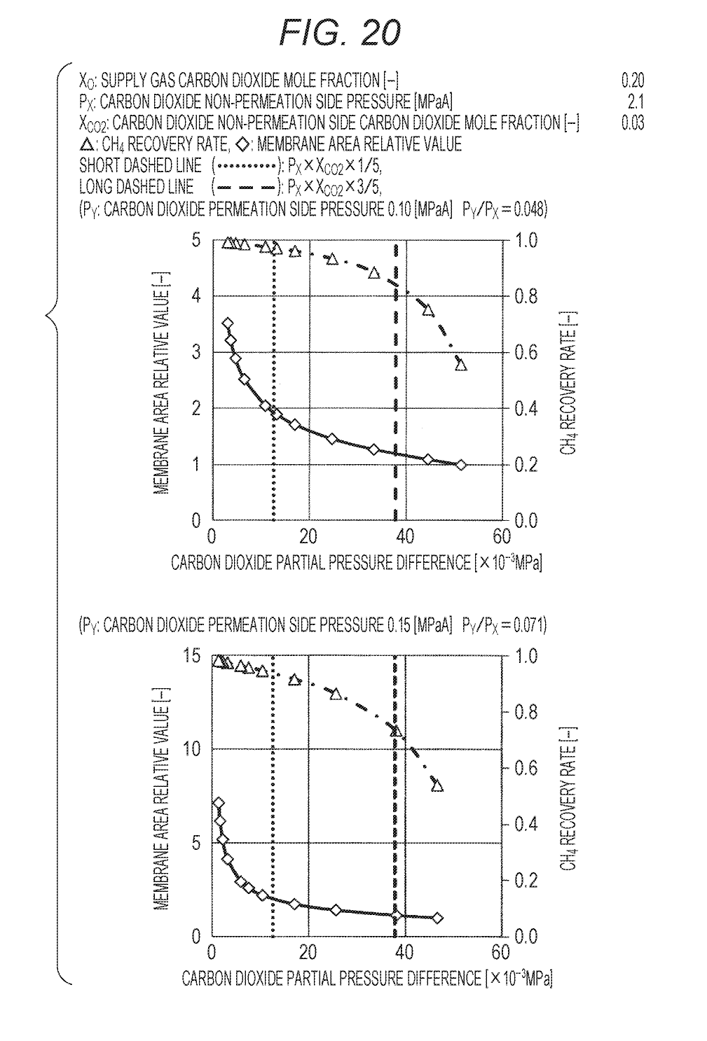

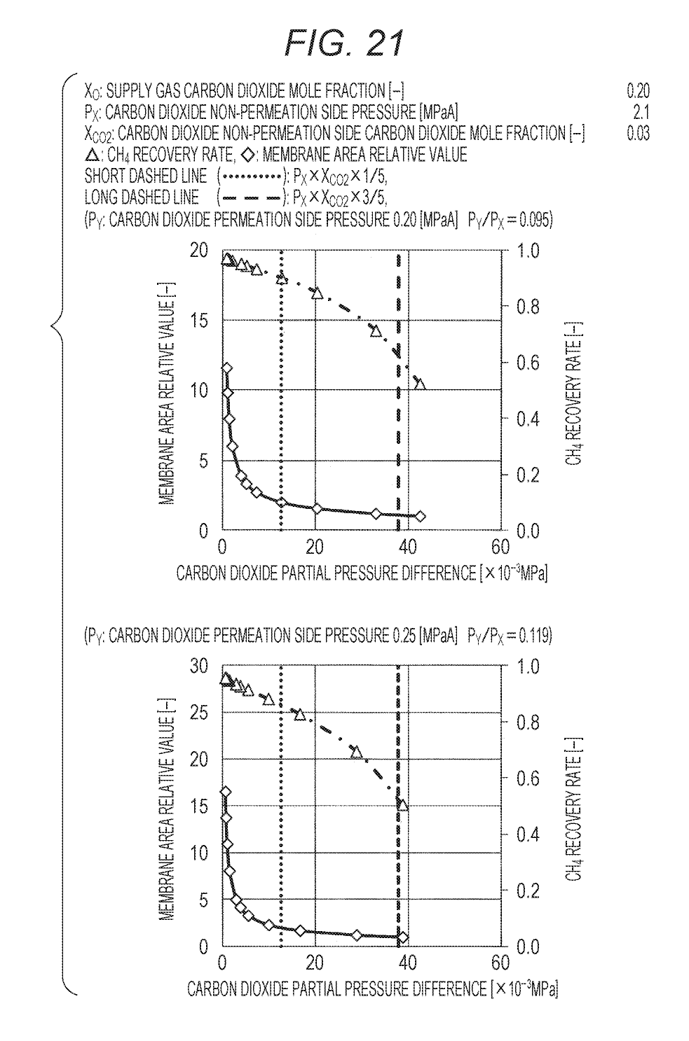

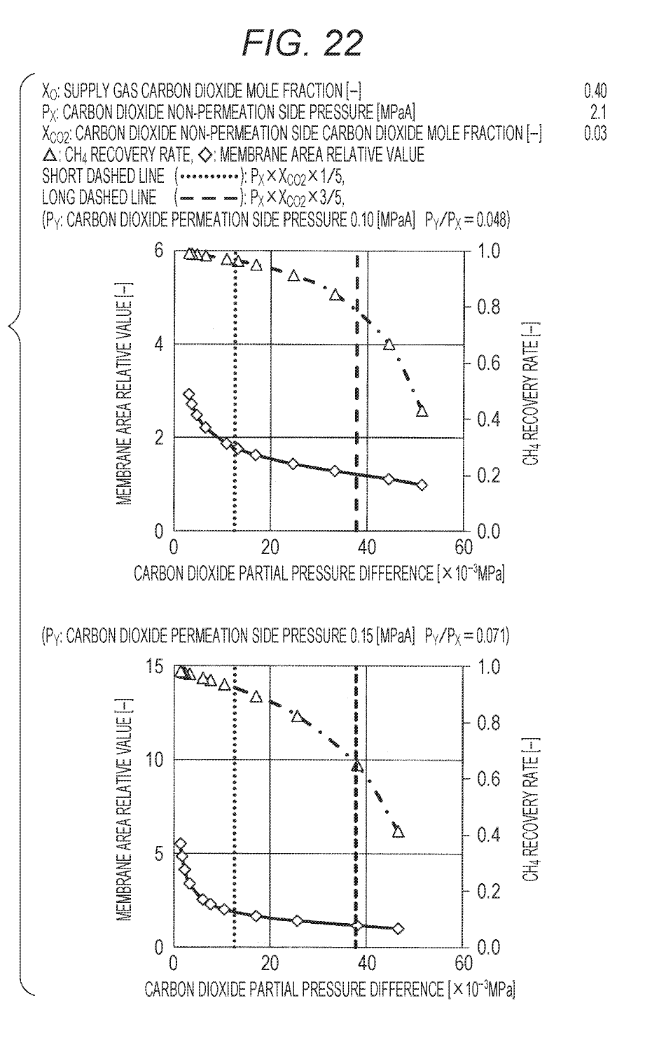

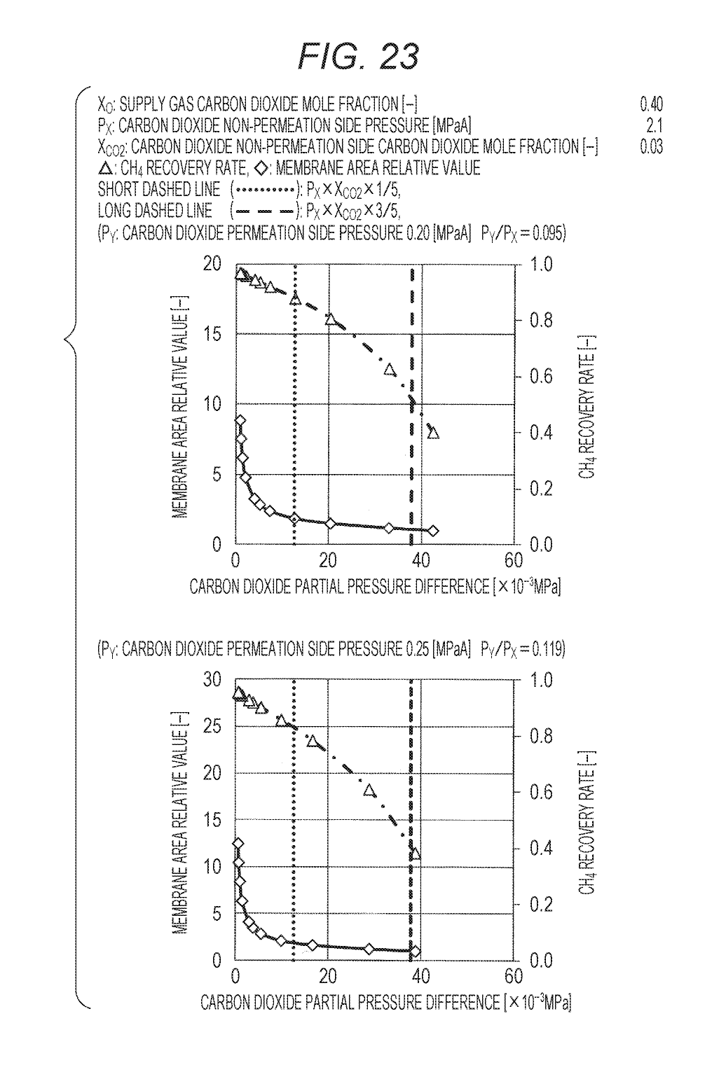

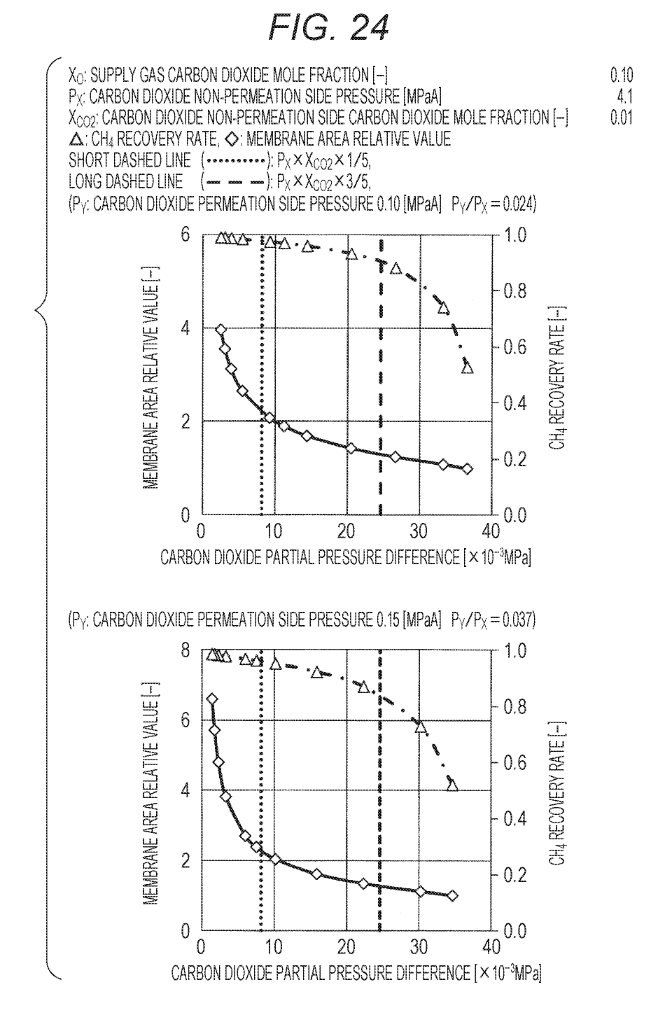

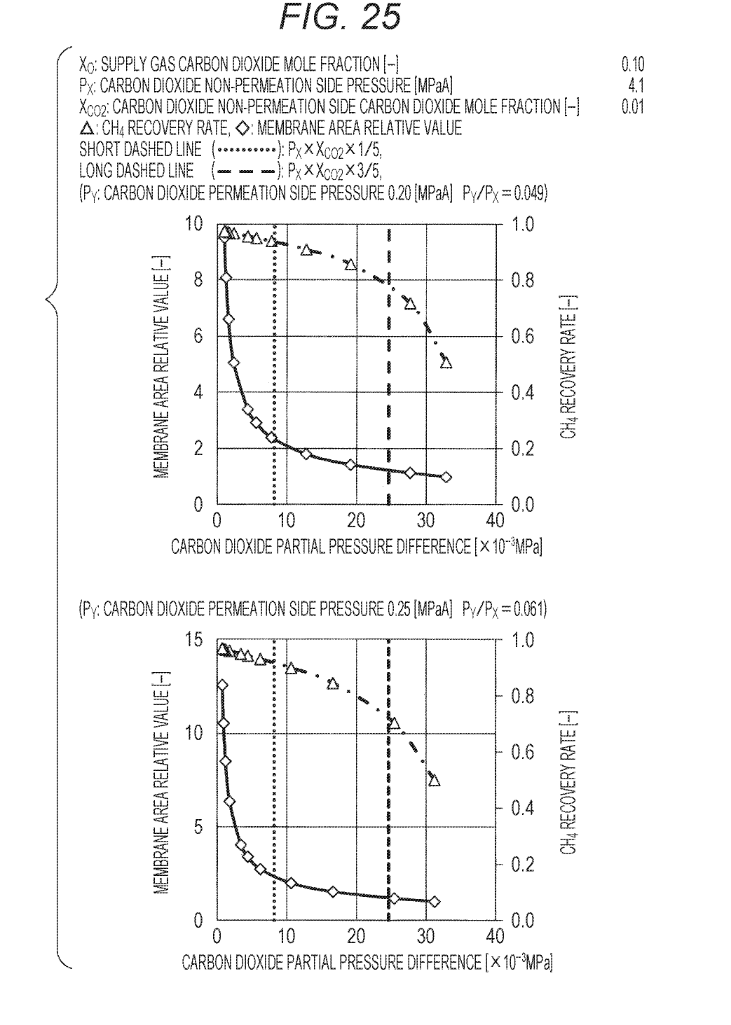

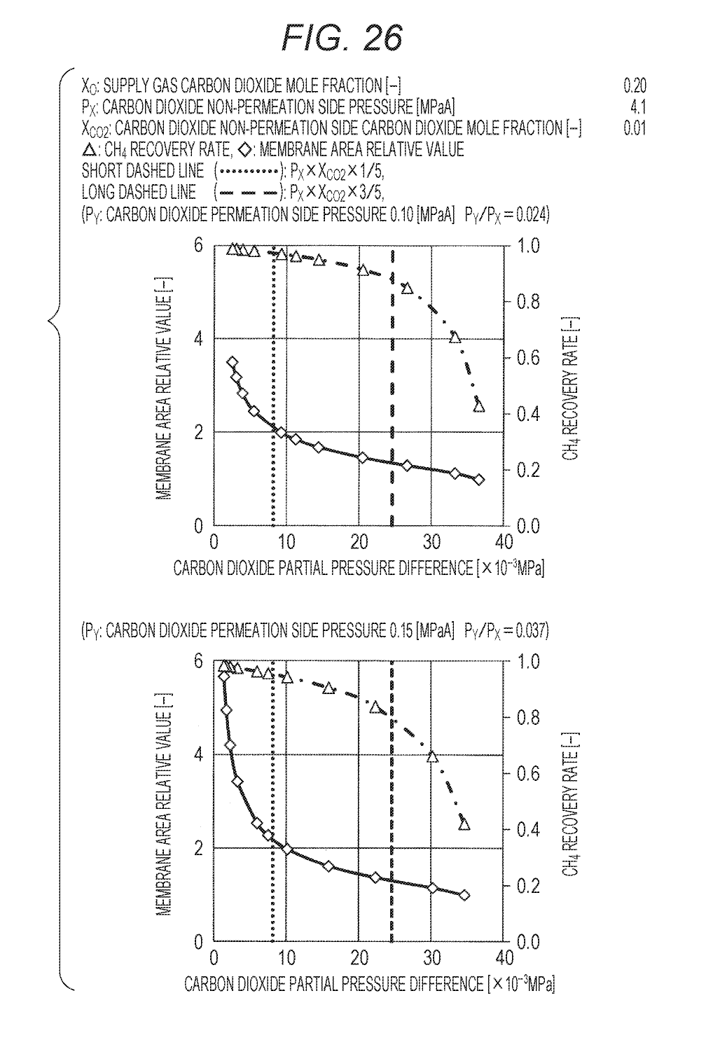

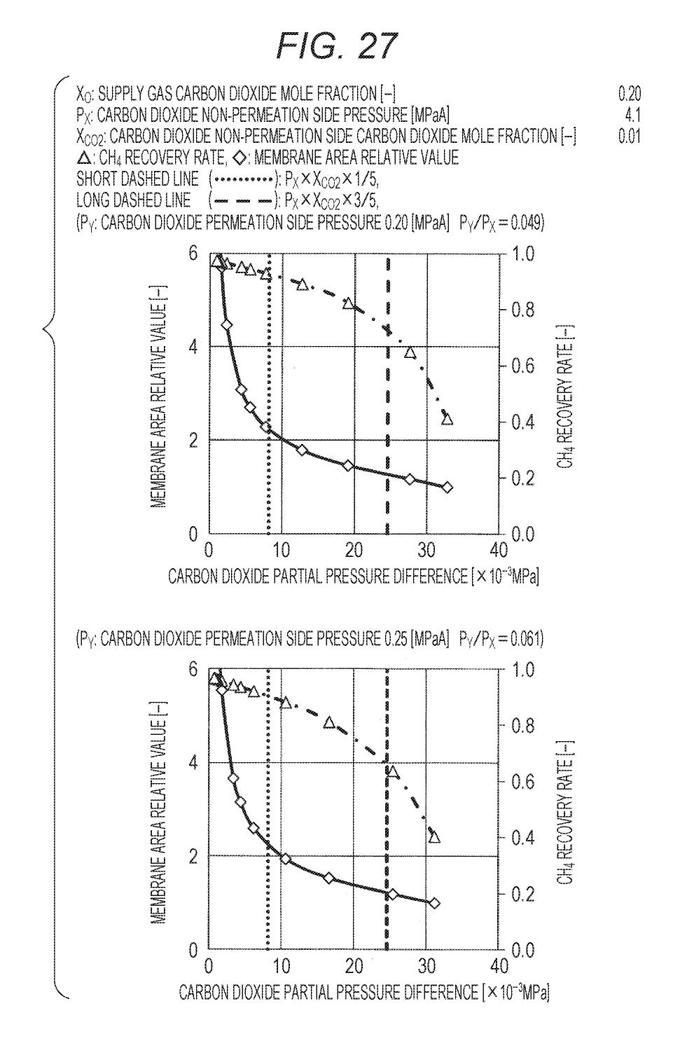

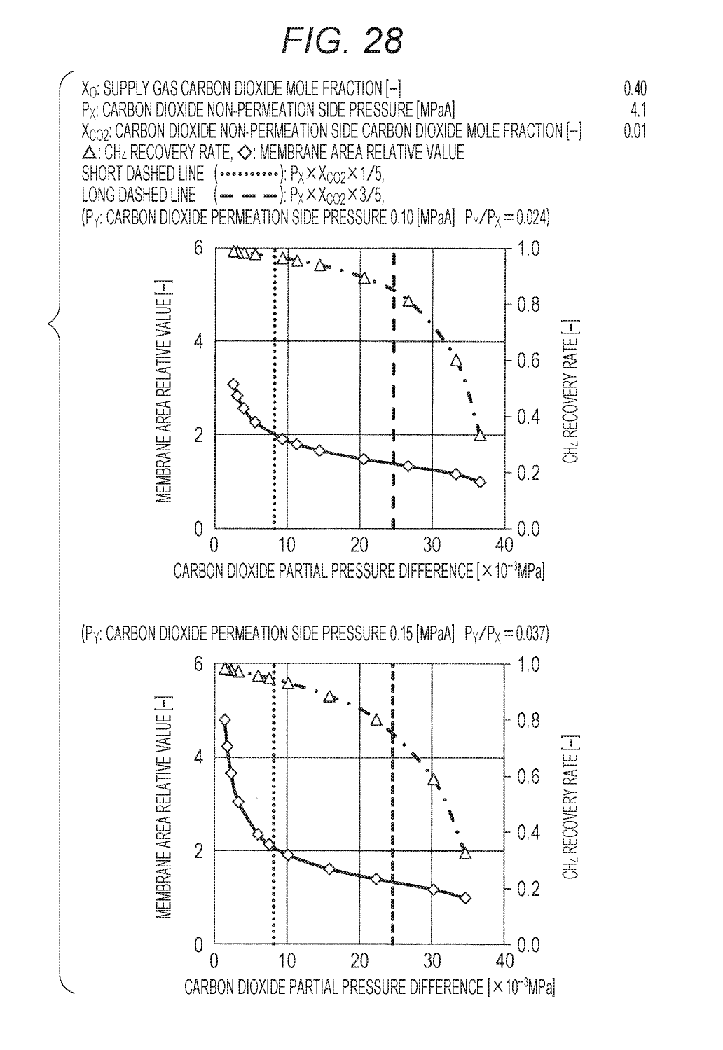

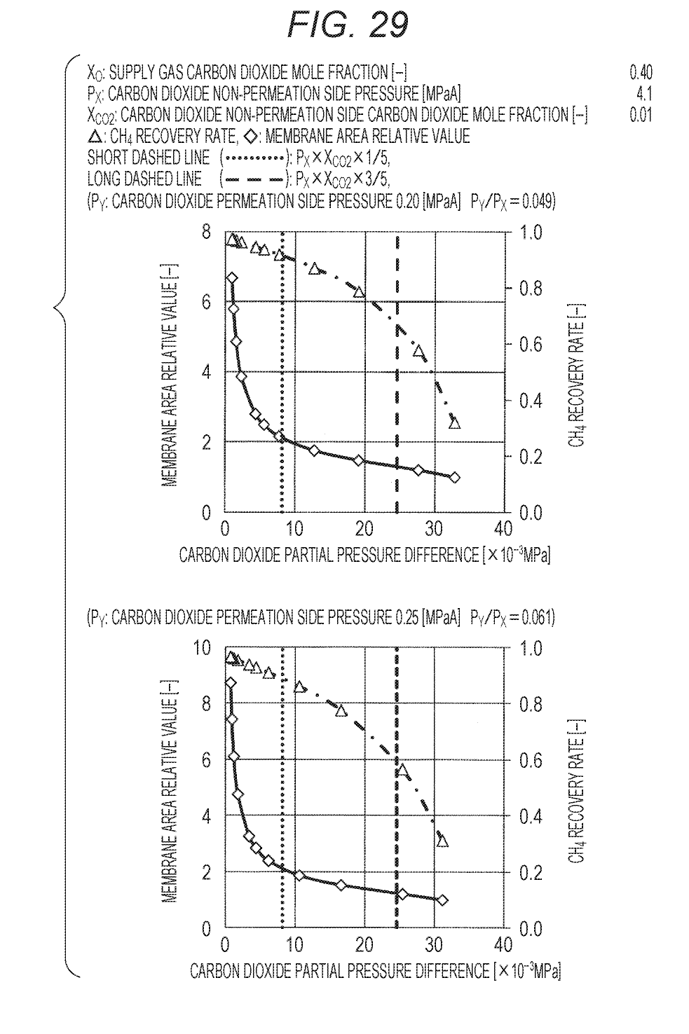

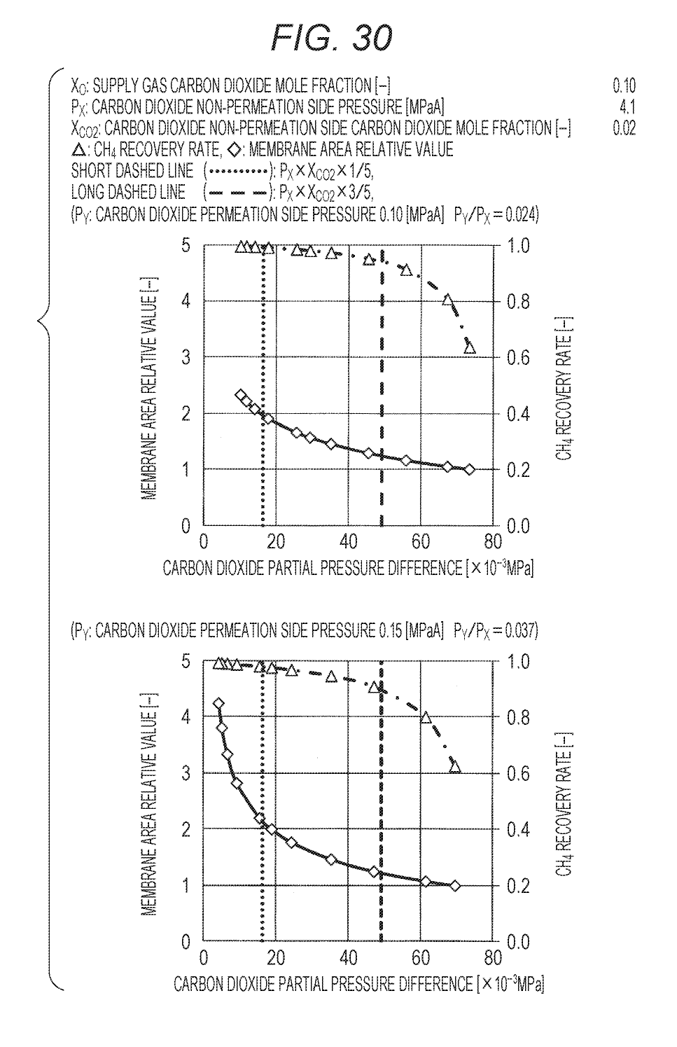

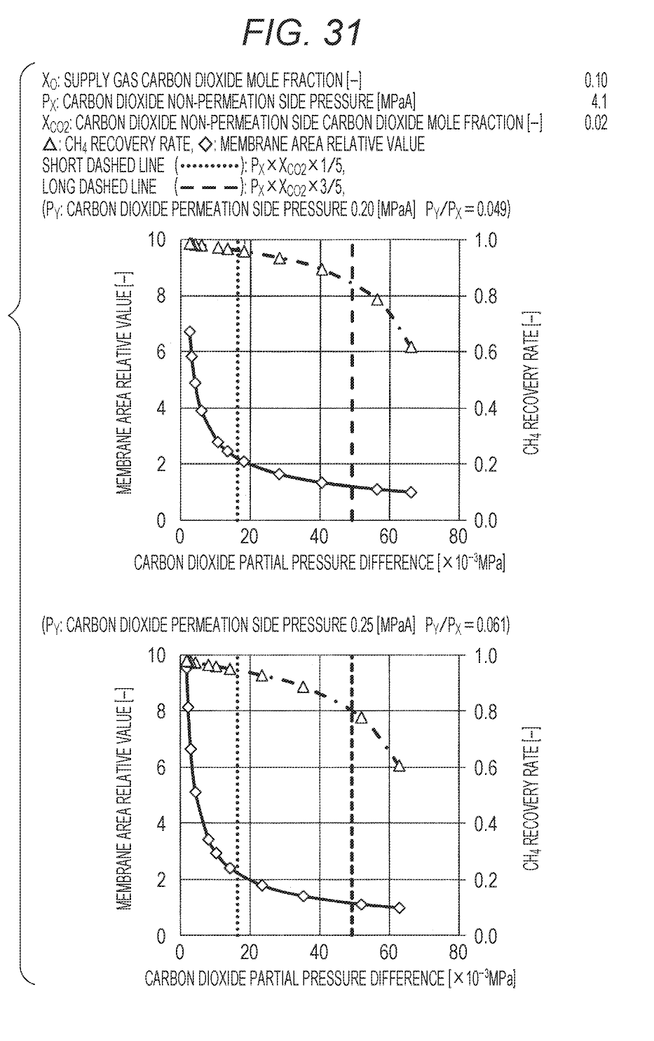

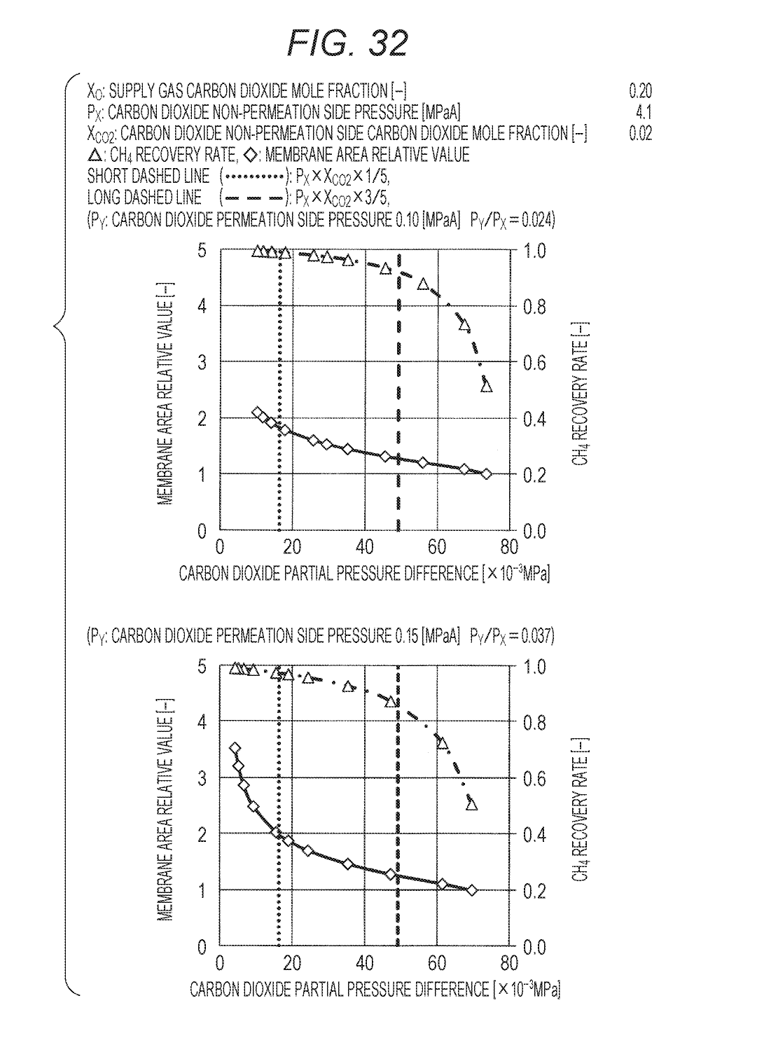

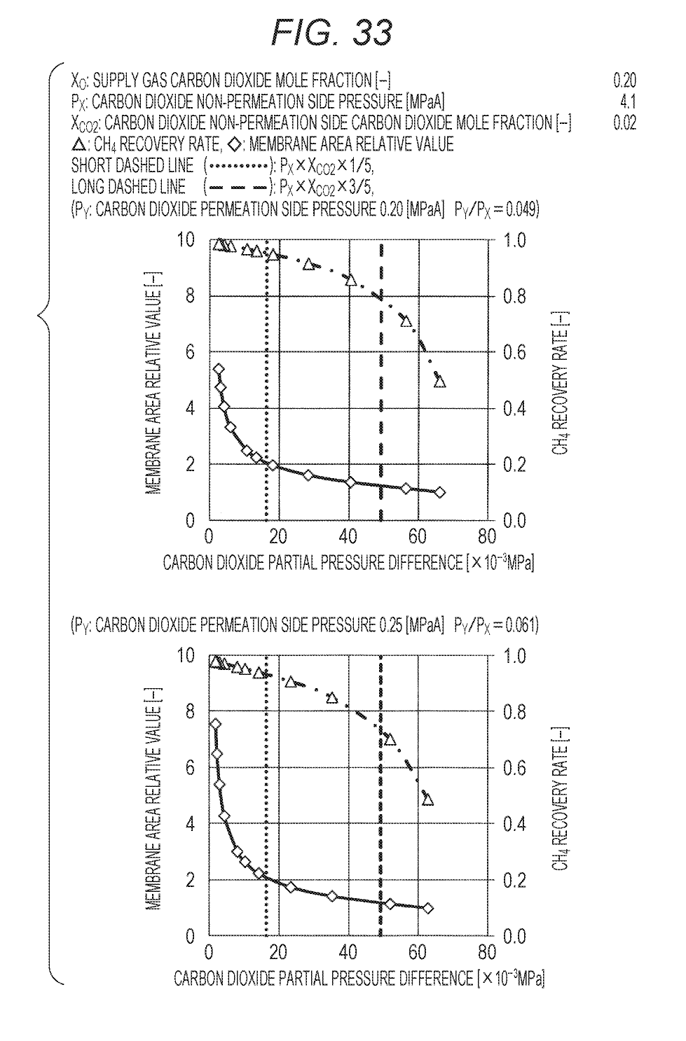

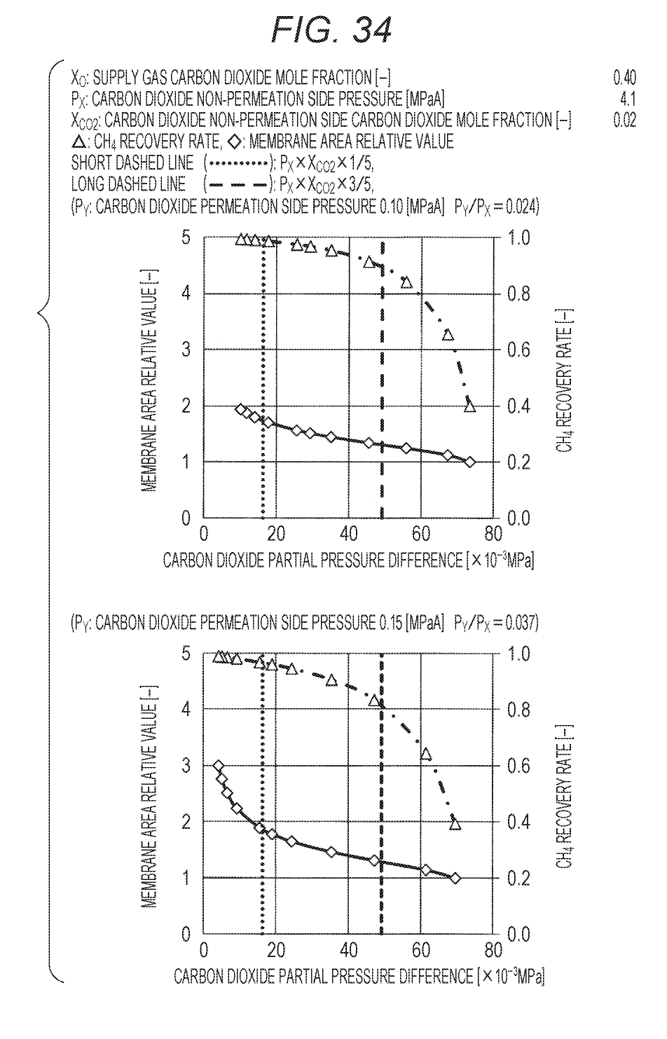

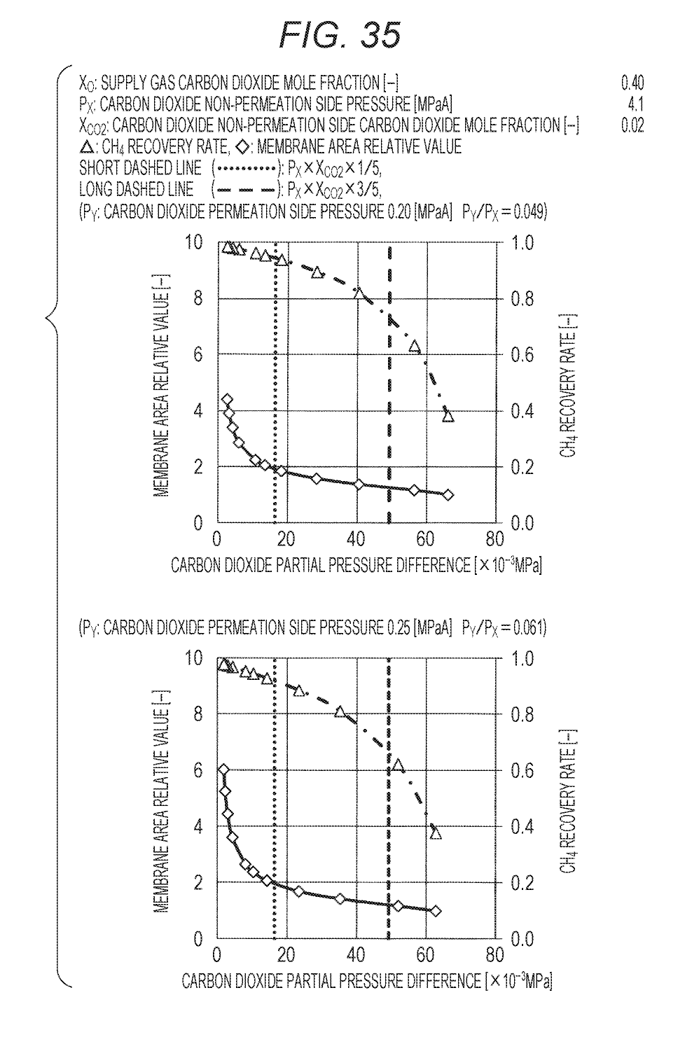

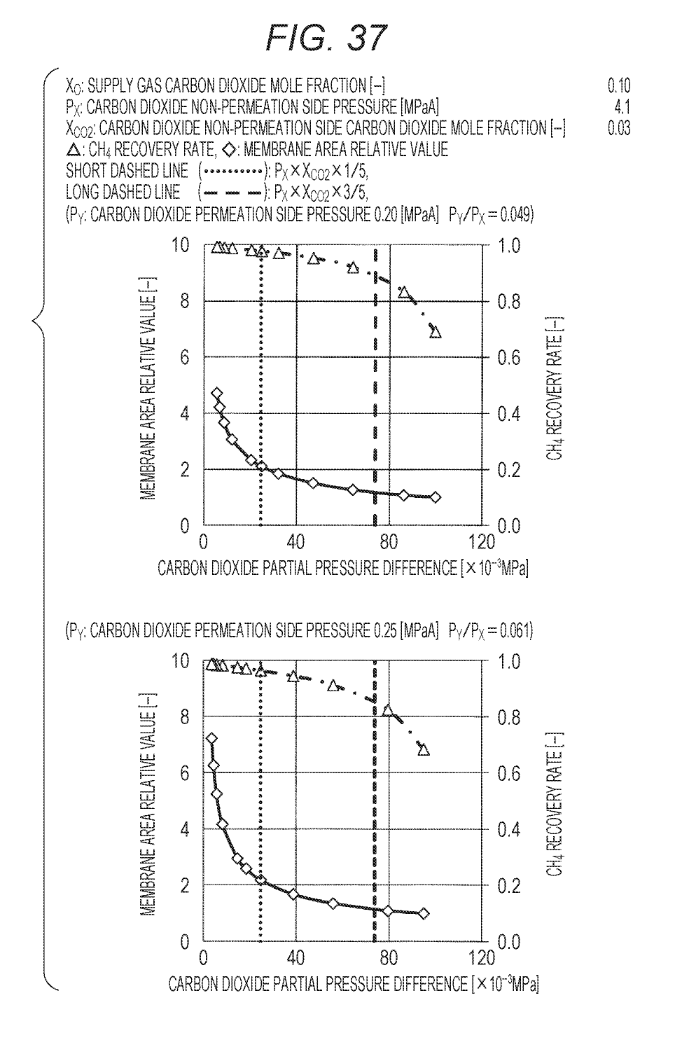

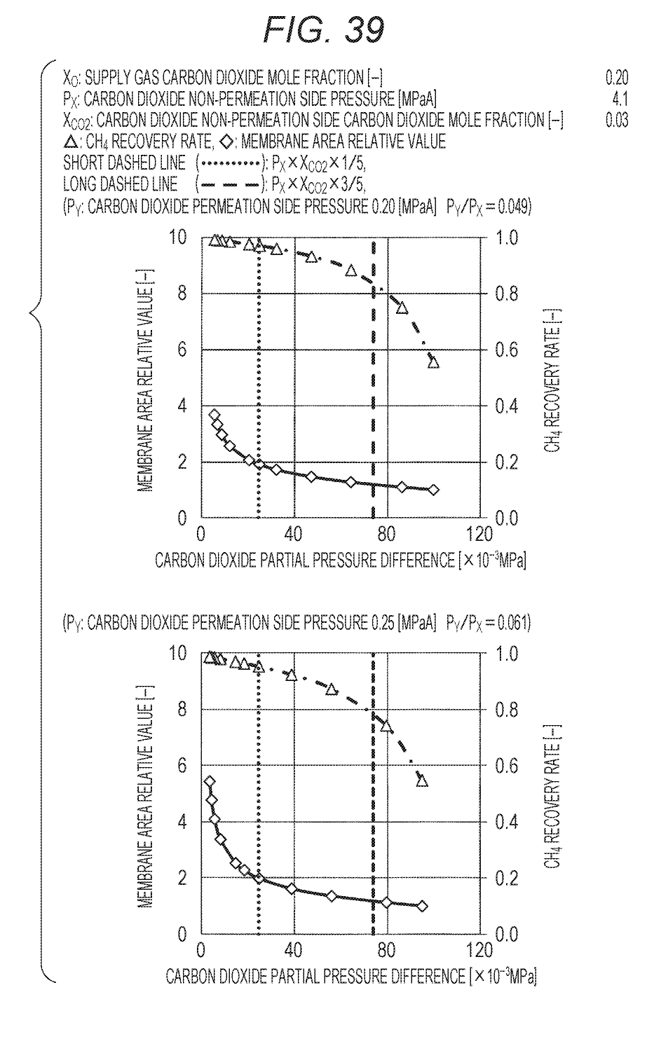

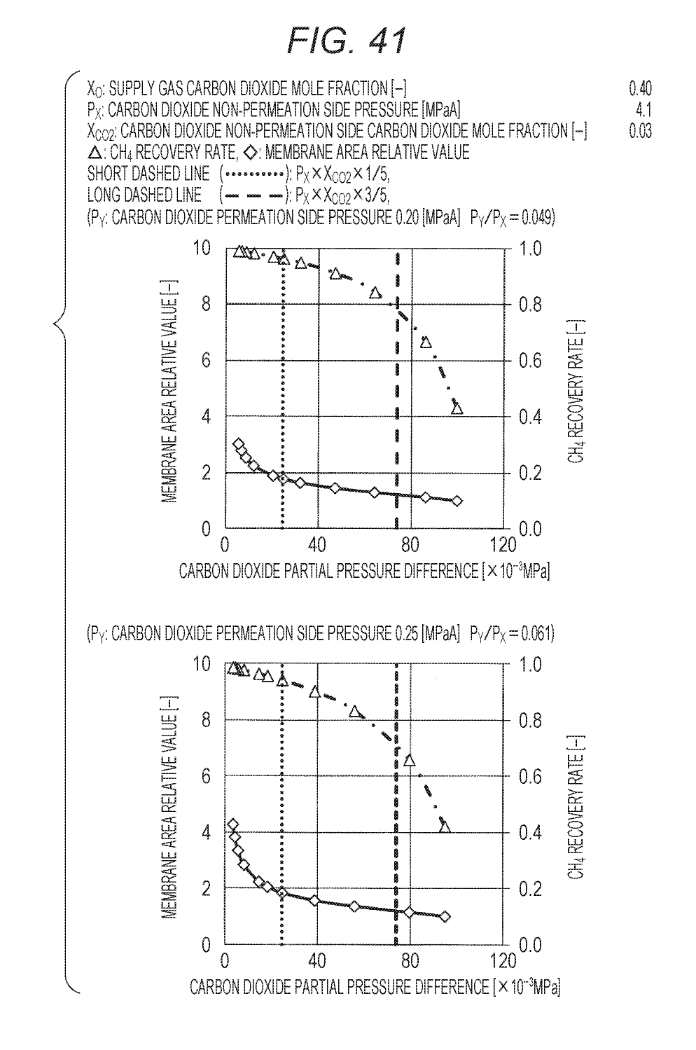

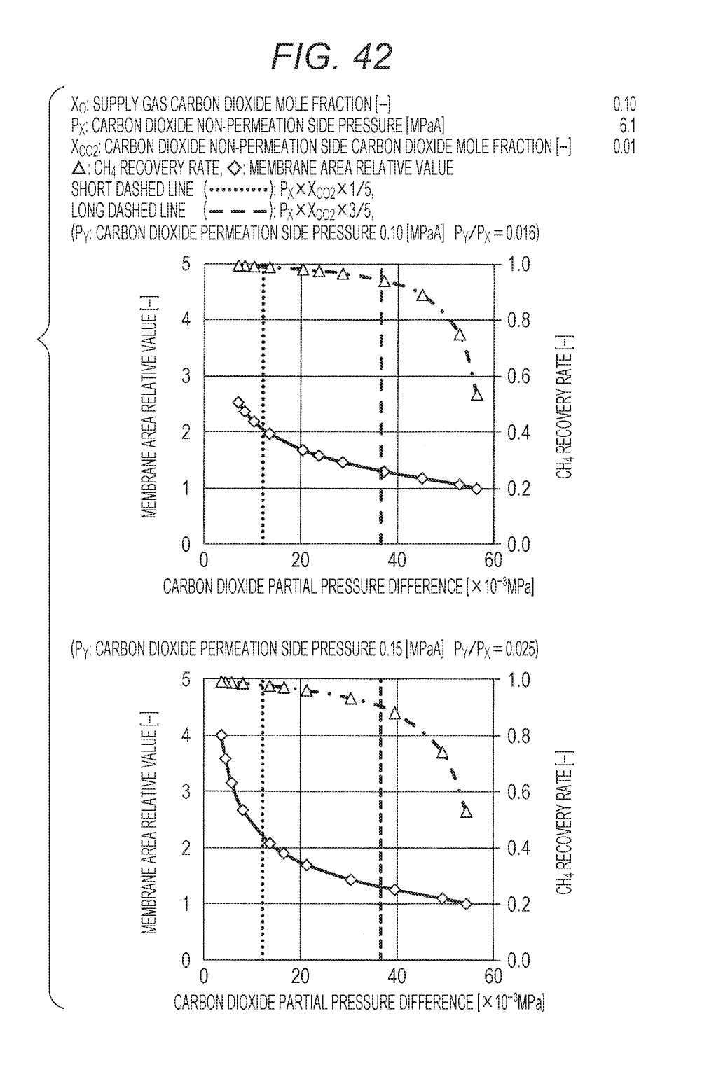

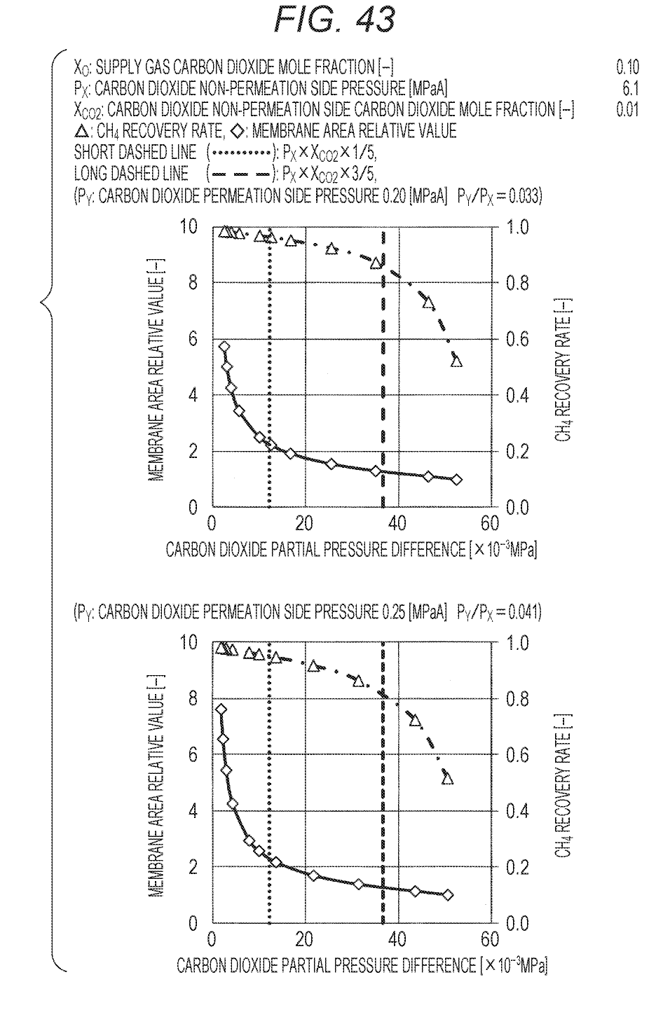

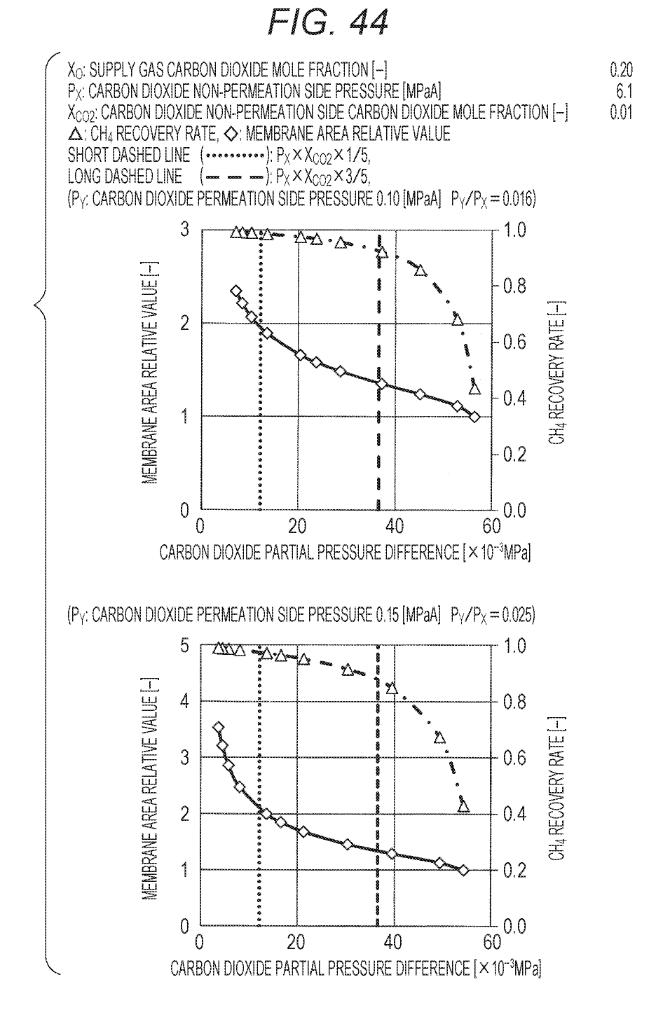

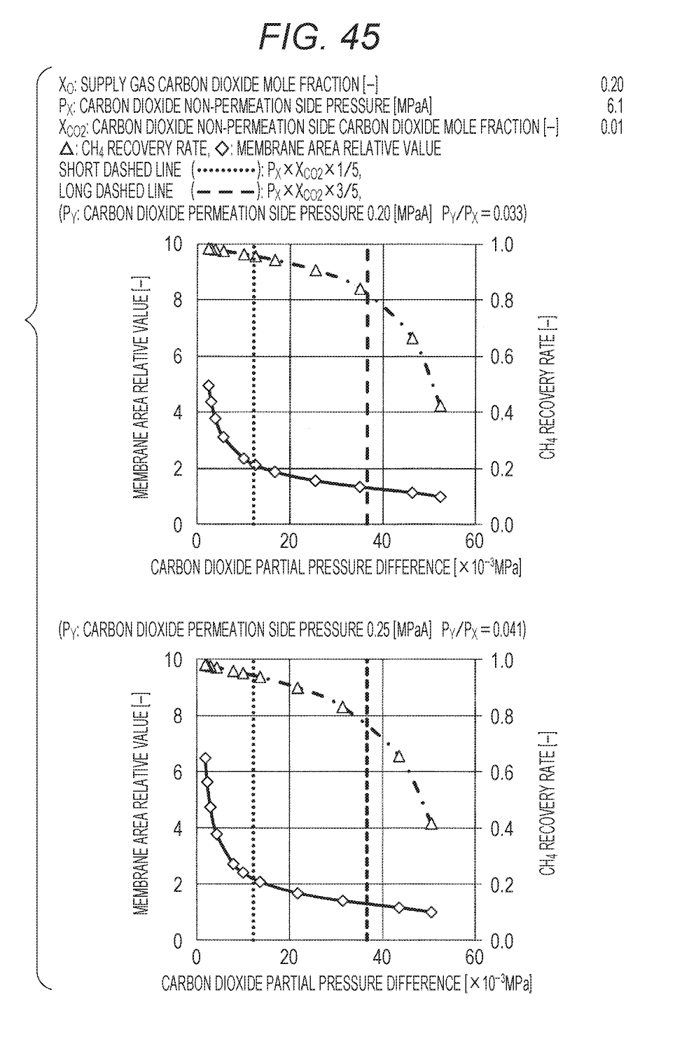

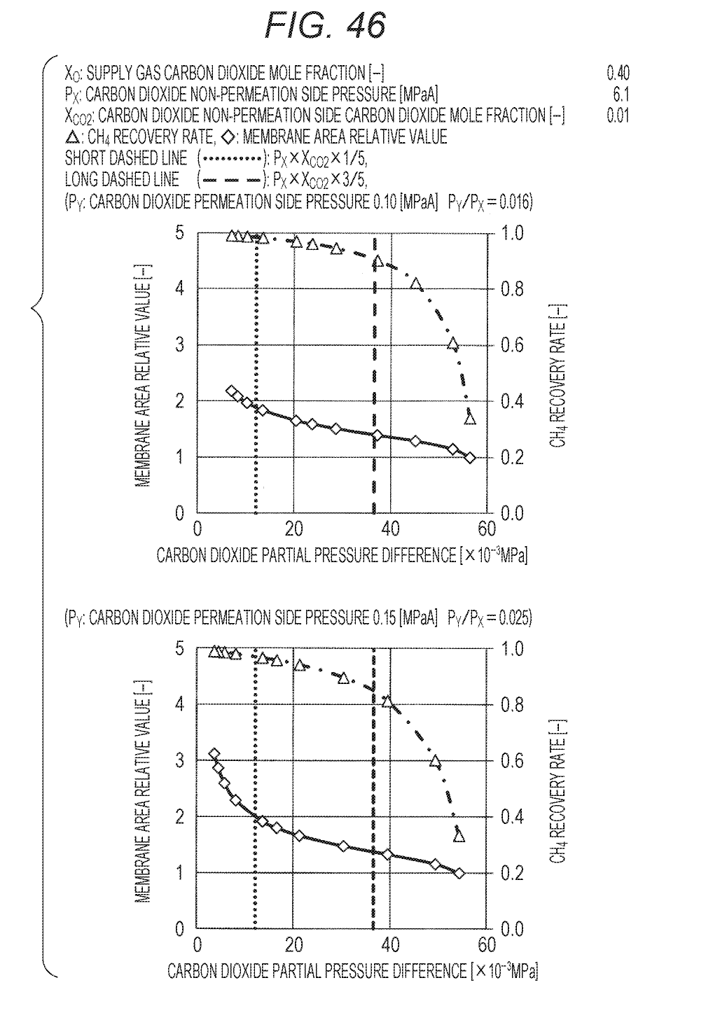

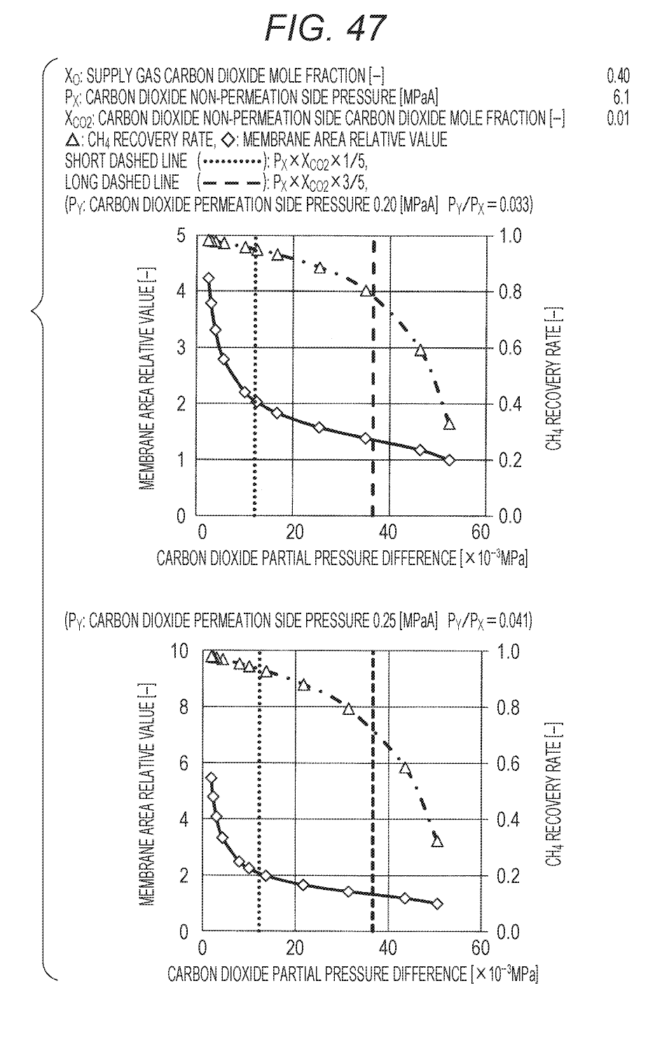

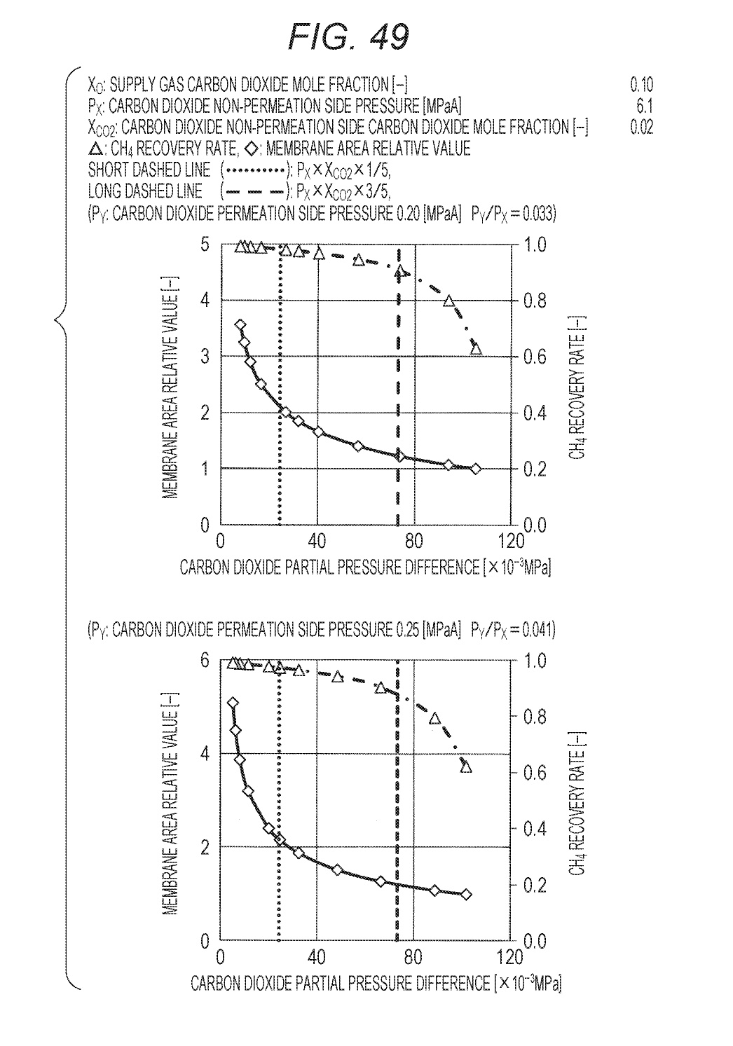

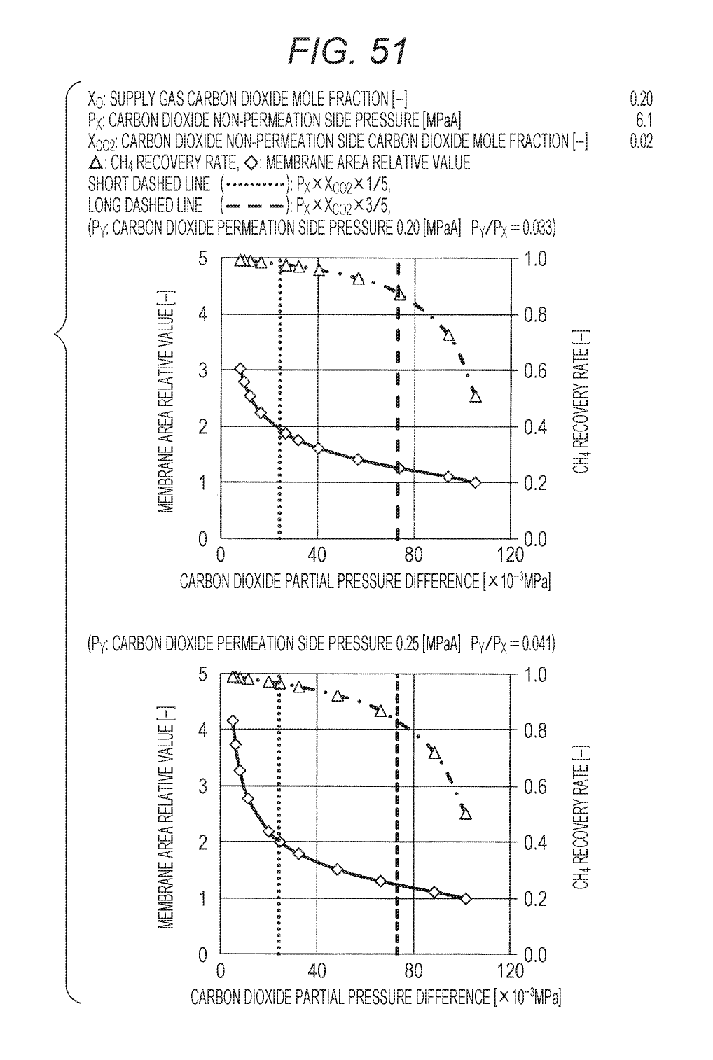

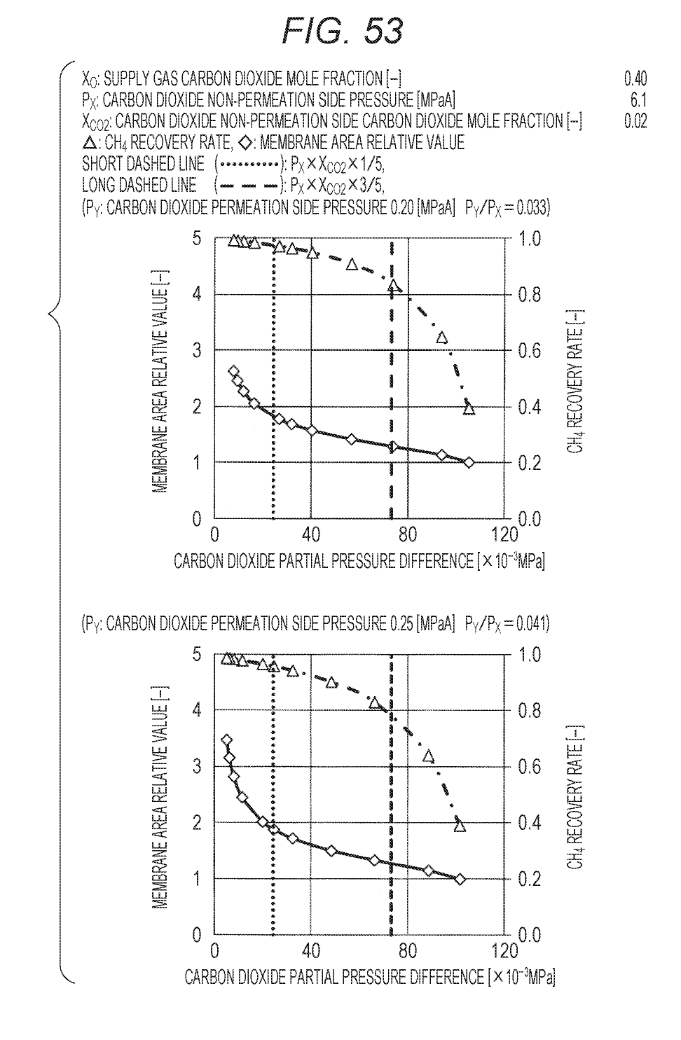

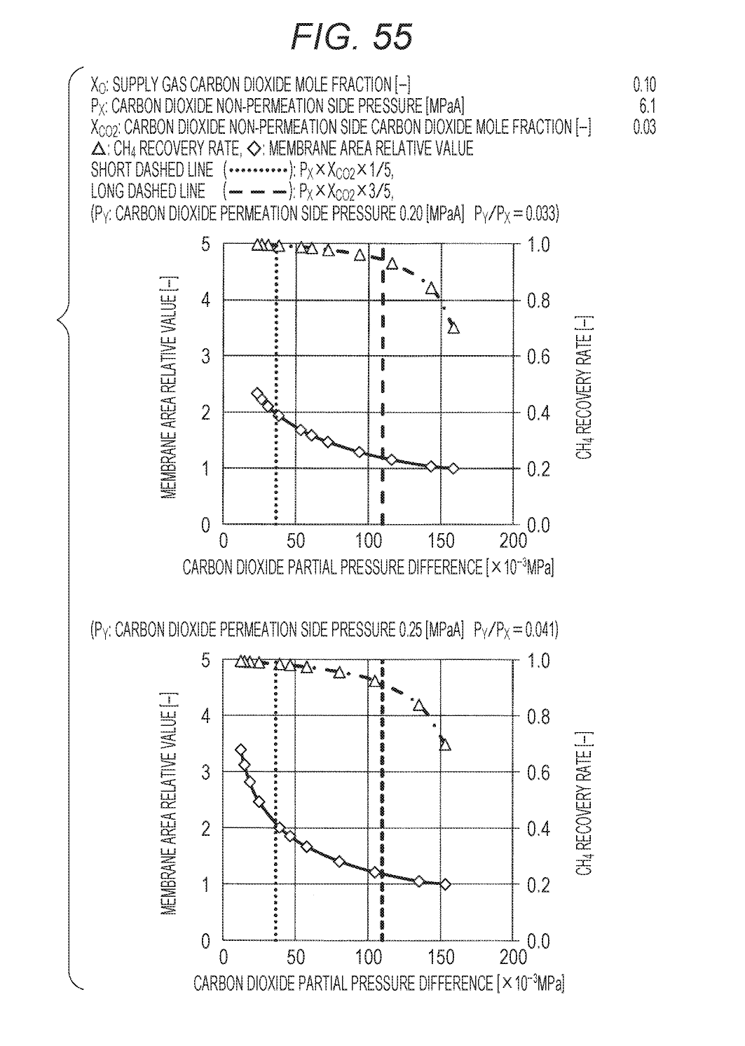

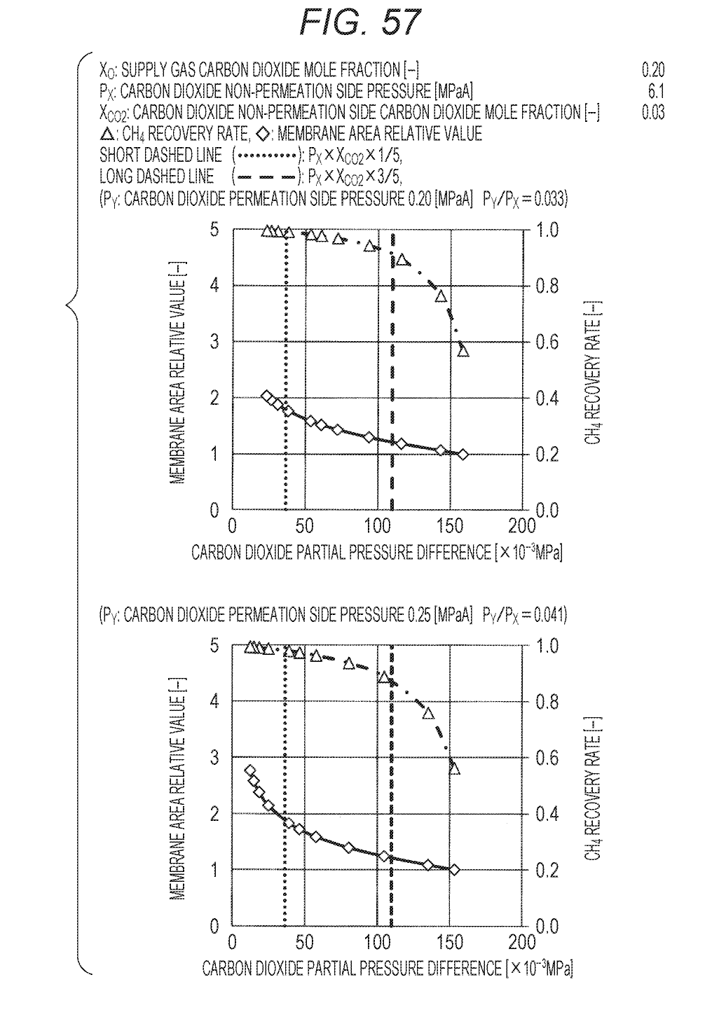

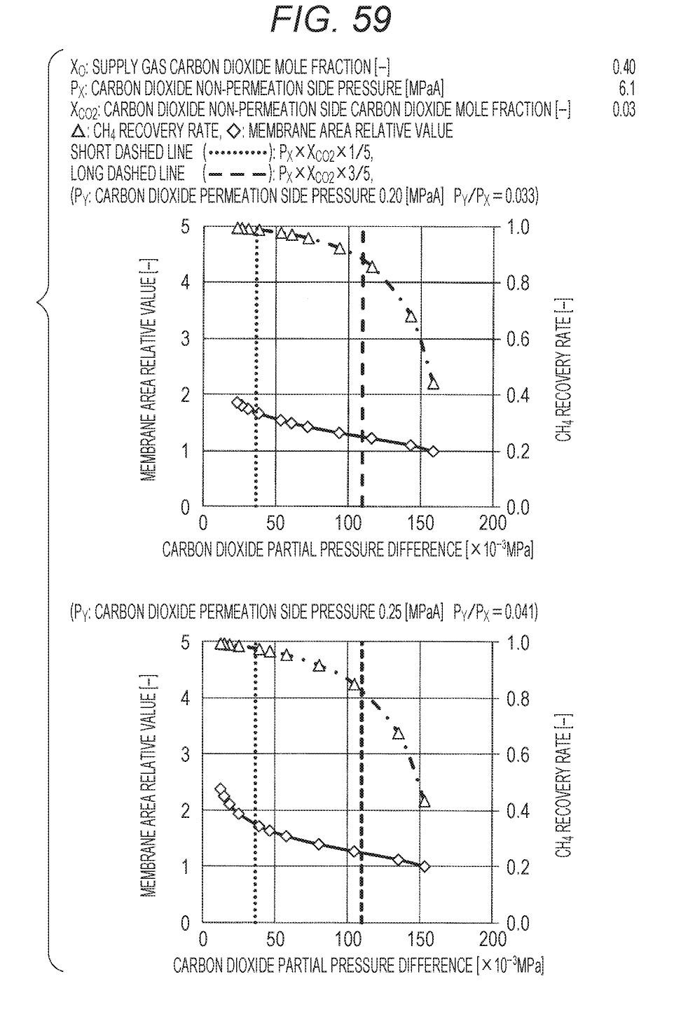

In addition, as to ΔP, from the calculation (simulation) results, the value at the final outlet on the carbon dioxide non-permeation side is extracted, and the relationship among the carbon dioxide partial pressure difference (ΔP), the membrane area relative value of an inorganic separation membrane, and the methane (CH₄) recovery rate is shown in FIG. 6 to FIG. 59.

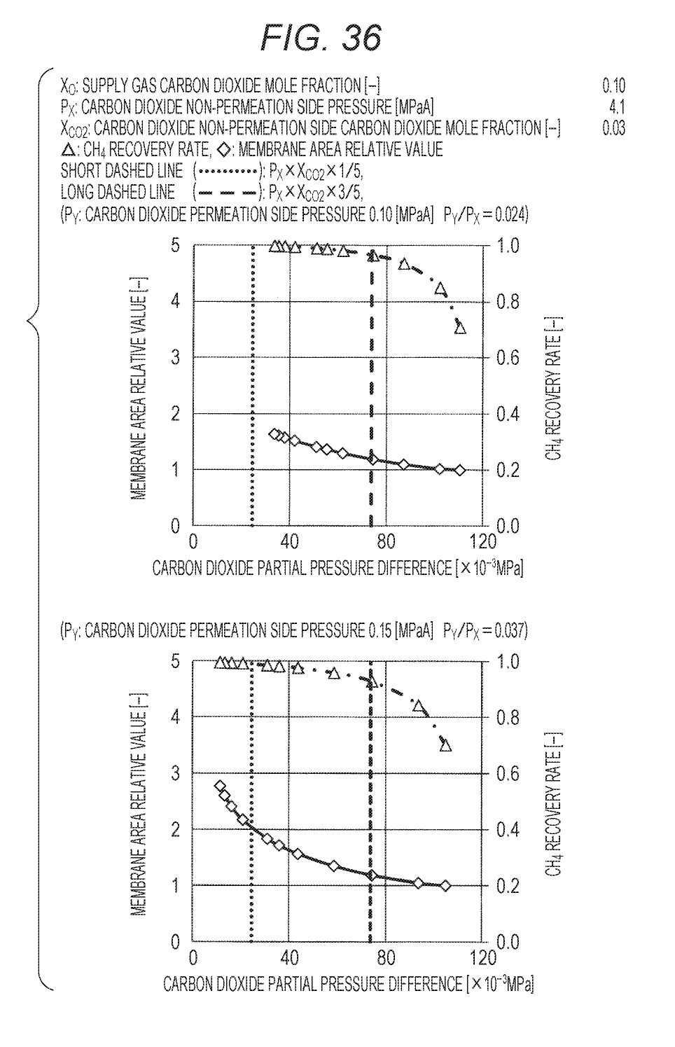

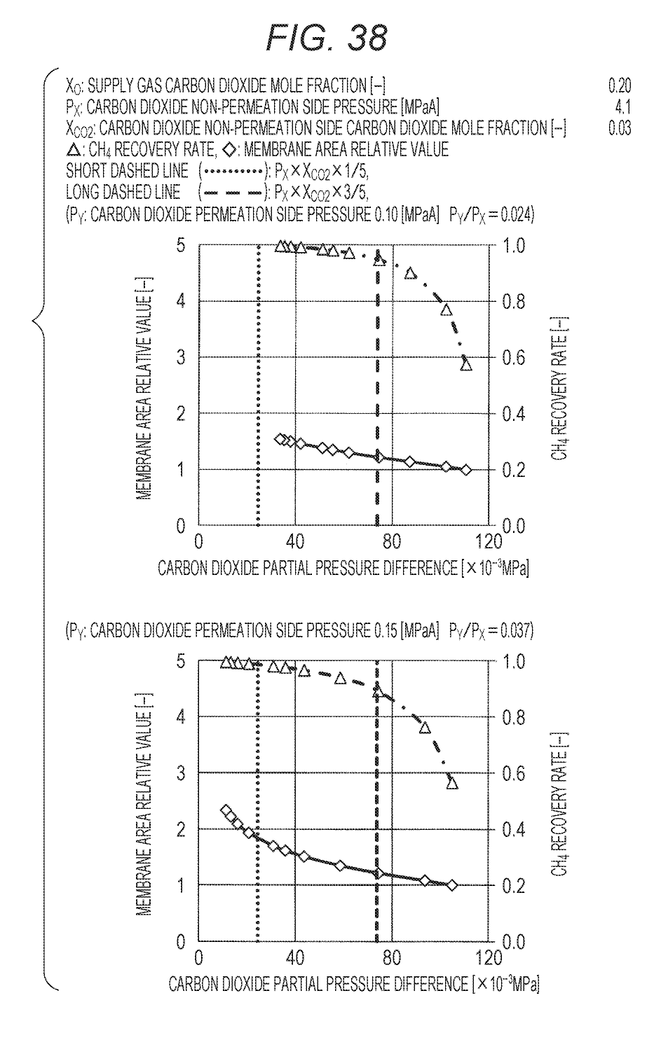

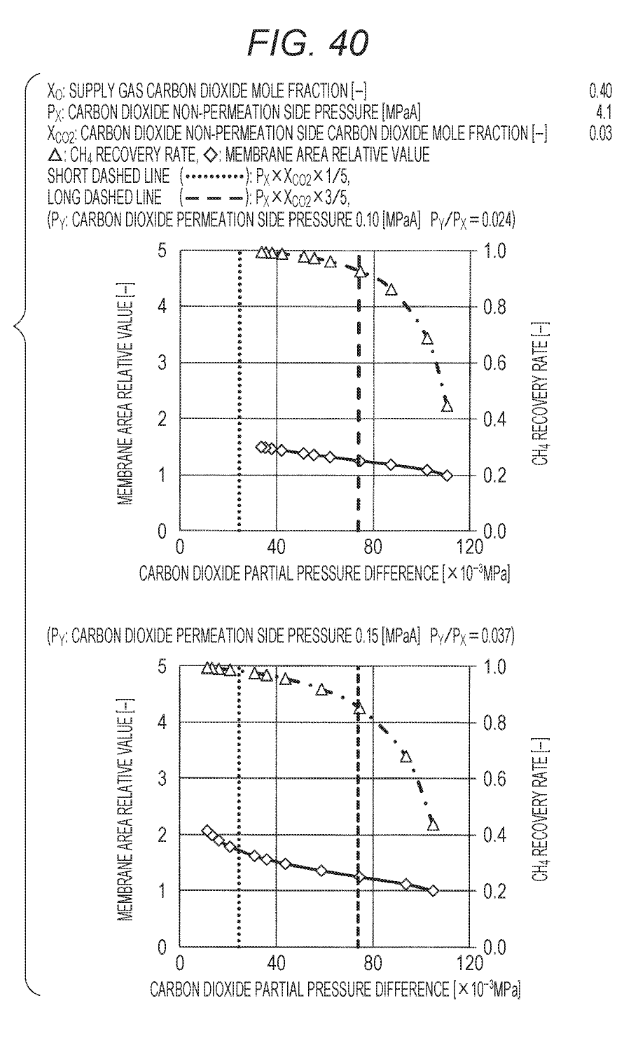

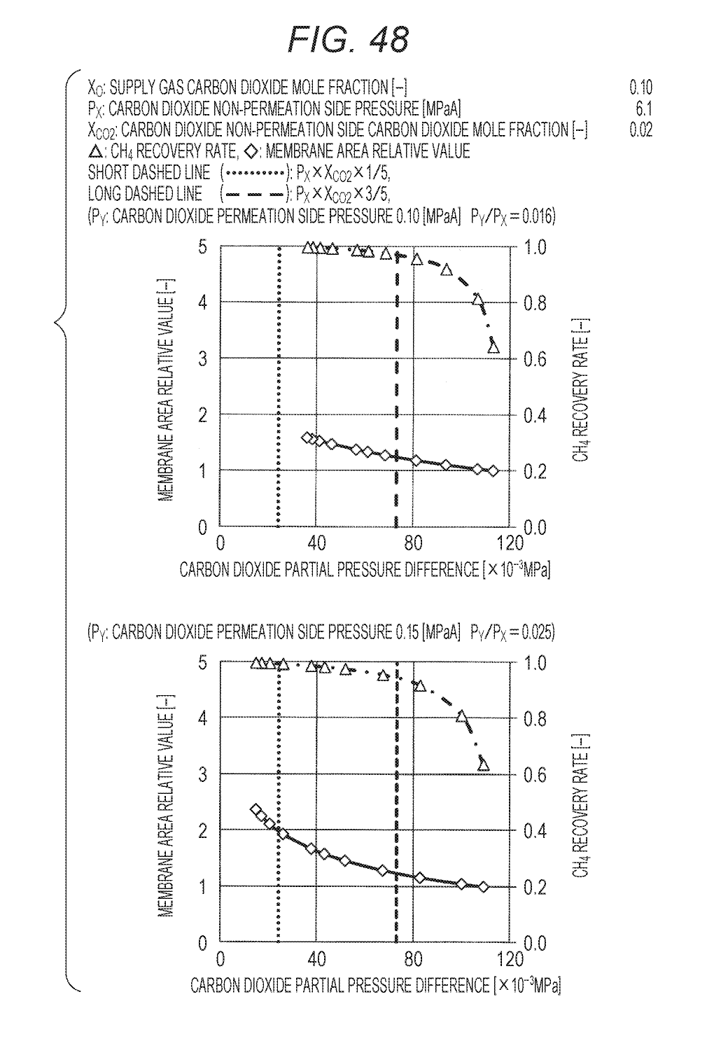

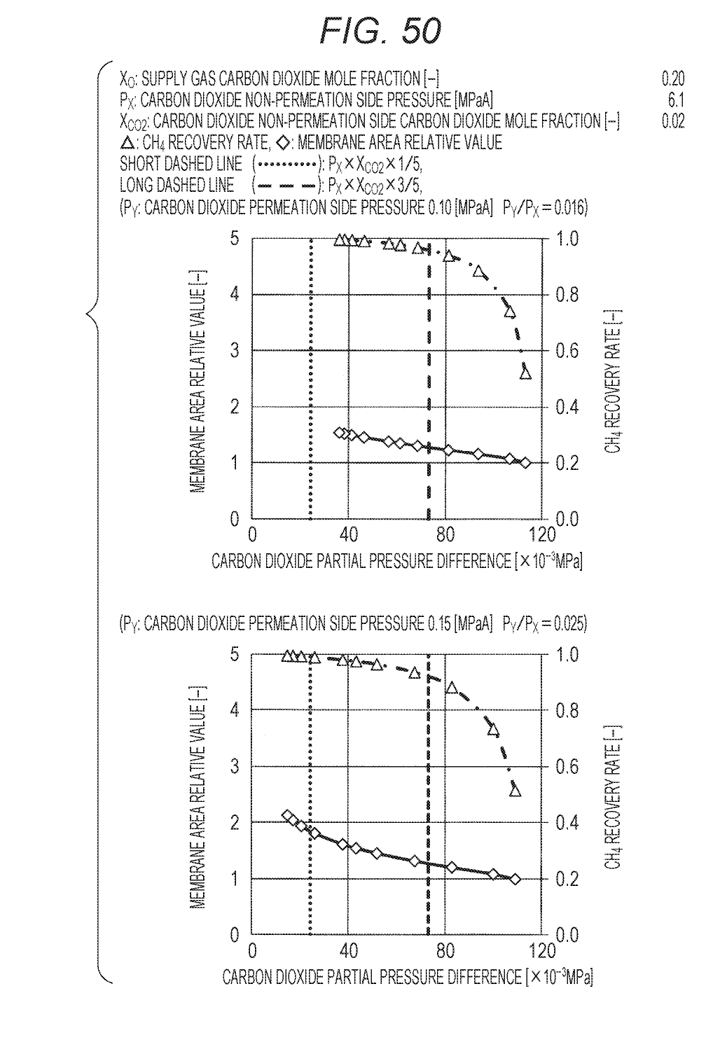

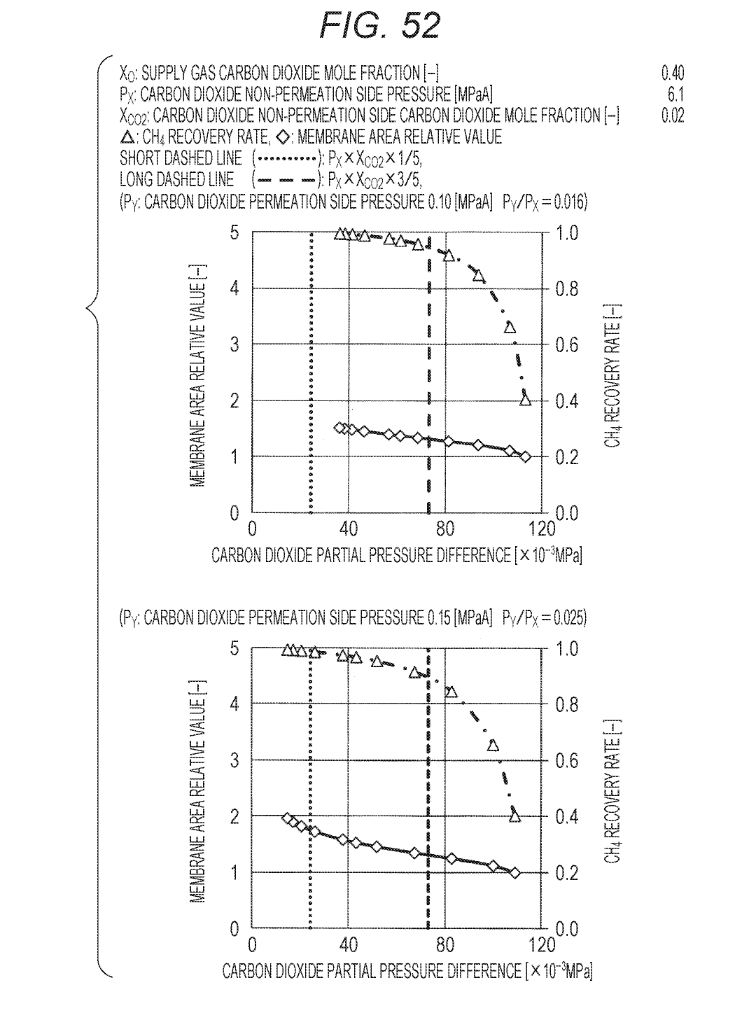

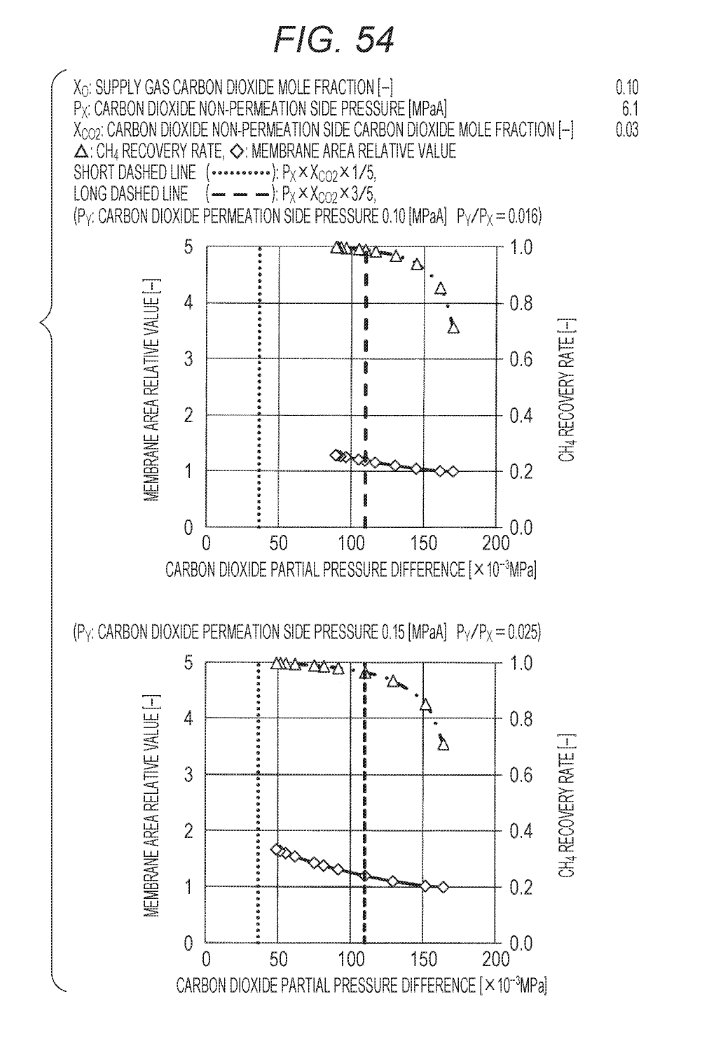

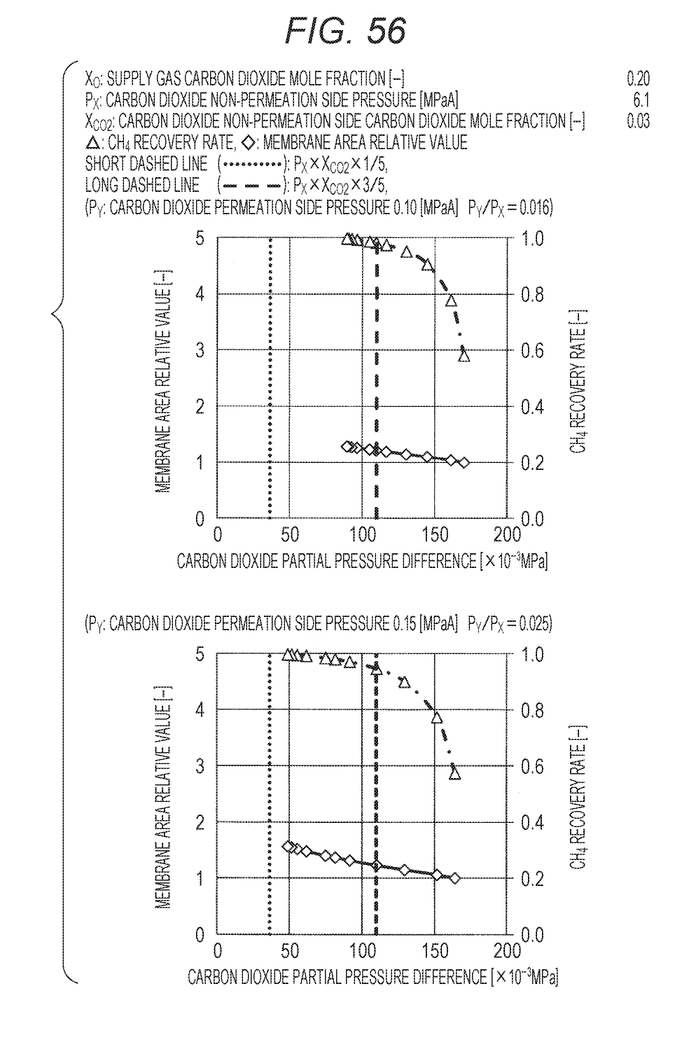

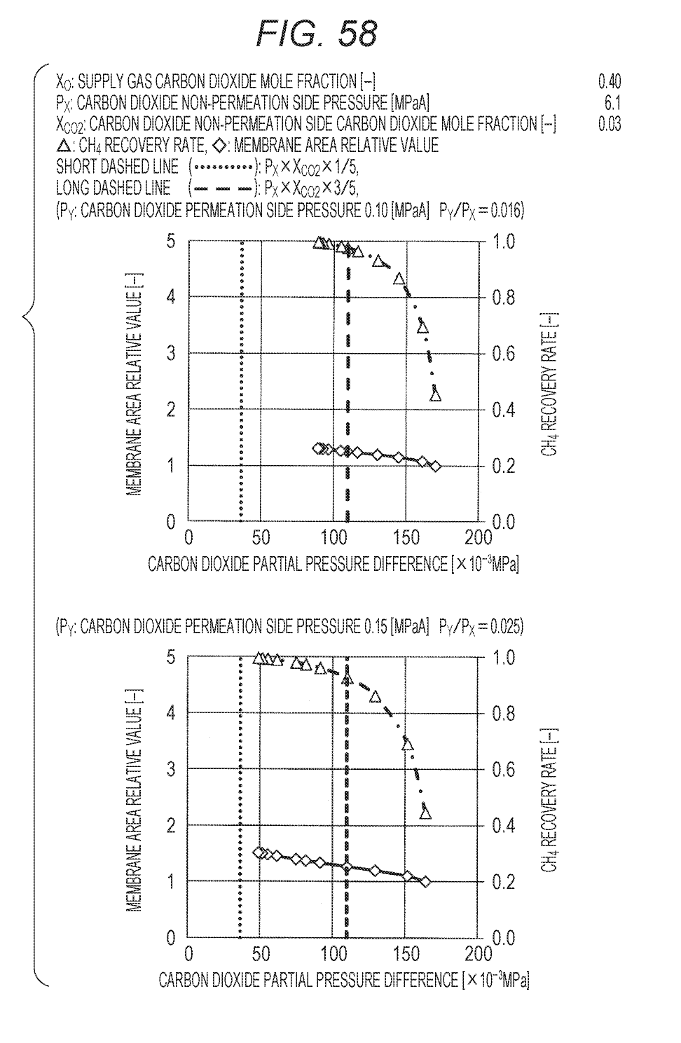

Further, Correspondence Tables of each combination of parameters and the drawing numbers are shown in Tables 1 to 3. In Tables 1 to 3, the numerical values of “P_{Y}/P_{X}” surrounded by thick lines (top of FIG. 36, top of FIG. 38, top of FIG. 40, top of FIG. 48, top of FIG. 50, top of FIG. 52, FIG. 54, FIG. 56, and FIG. 58) indicates a case where X_{CO2} is larger than P_{Y}/P_{X}. The positions of the short dashed line ((⅕)·P_{X}·X_{CO2}) and the long dashed line ((⅗)·P_{X}·X_{CO2}) in each drawing are determined by obtaining P_{X}·X_{CO2} [MPa] under the conditions to be subjected and calculating from the obtained value.

### (Correspondence Table)

TABLE 1

| | | | Carbon | | | |
|---|---|---|---|---|---|---|
| | | | dioxide | | | |
| | | | mole | | | |
| | | Supply | fraction | Carbon | | |
| | | gas | on carbon | dioxide | Carbon | |
| | | carbon | dioxide | non- | dioxide | |
| | | dioxide | non- | permeation | permeation | |
| | | mole | permeation | side | side | |
| Drawing | Top or | fraction | side | pressure | pressure | |
| number | bottom | X₀ [−] | X_{co2} [−] | Pₓ [MPaA] | P_{Y} [MPaA] | P_{Y}/Pₓ |
| 6 | Top | 0.10 | 0.01 | 2.1 | 0.10 | 0.048 |
| | Bottom | 0.10 | 0.01 | 2.1 | 0.15 | 0.071 |
| 7 | Top | 0.10 | 0.01 | 2.1 | 0.20 | 0.095 |
| | Bottom | 0.10 | 0.01 | 2.1 | 0.25 | 0.119 |
| 8 | Top | 0.20 | 0.01 | 2.1 | 0.10 | 0.048 |
| | Bottom | 0.20 | 0.01 | 2.1 | 0.15 | 0.071 |
| 9 | Top | 0.20 | 0.01 | 2.1 | 0.20 | 0.095 |
| | Bottom | 0.20 | 0.01 | 2.1 | 0.25 | 0.119 |
| 10 | Top | 0.40 | 0.01 | 2.1 | 0.10 | 0.048 |
| | Bottom | 0.40 | 0.01 | 2.1 | 0.15 | 0.071 |
| 11 | Top | 0.40 | 0.01 | 2.1 | 0.20 | 0.095 |
| | Bottom | 0.40 | 0.01 | 2.1 | 0.25 | 0.119 |
| 12 | Top | 0.10 | 0.02 | 2.1 | 0.10 | 0.048 |
| | Bottom | 0.10 | 0.02 | 2.1 | 0.15 | 0.071 |
| 13 | Top | 0.10 | 0.02 | 2.1 | 0.20 | 0.095 |
| | Bottom | 0.10 | 0.02 | 2.1 | 0.25 | 0.119 |
| 14 | Top | 0.20 | 0.02 | 2.1 | 0.10 | 0.048 |
| | Bottom | 0.20 | 0.02 | 2.1 | 0.15 | 0.071 |
| 15 | Top | 0.20 | 0.02 | 2.1 | 0.20 | 0.095 |
| | Bottom | 0.20 | 0.02 | 2.1 | 0.25 | 0.119 |
| 16 | Top | 0.40 | 0.02 | 2.1 | 0.10 | 0.048 |
| | Bottom | 0.40 | 0.02 | 2.1 | 0.15 | 0.071 |
| 17 | Top | 0.40 | 0.02 | 2.1 | 0.20 | 0.095 |
| | Bottom | 0.40 | 0.02 | 2.1 | 0.25 | 0.119 |
| 18 | Top | 0.10 | 0.03 | 2.1 | 0.10 | 0.048 |
| | Bottom | 0.10 | 0.03 | 2.1 | 0.15 | 0.071 |
| 19 | Top | 0.10 | 0.03 | 2.1 | 0.20 | 0.095 |
| | Bottom | 0.10 | 0.03 | 2.1 | 0.25 | 0.119 |
| 20 | Top | 0.20 | 0.03 | 2.1 | 0.10 | 0.048 |
| | Bottom | 0.20 | 0.03 | 2.1 | 0.15 | 0.071 |
| 21 | Top | 0.20 | 0.03 | 2.1 | 0.20 | 0.095 |
| | Bottom | 0.20 | 0.03 | 2.1 | 0.25 | 0.119 |
| 22 | Top | 0.40 | 0.03 | 2.1 | 0.10 | 0.048 |
| | Bottom | 0.40 | 0.03 | 2.1 | 0.15 | 0.071 |
| 23 | Top | 0.40 | 0.03 | 2.1 | 0.20 | 0.095 |
| | Bottom | 0.40 | 0.03 | 2.1 | 0.25 | 0.119 |

(Correspondence Table)
(Correspondence Table)

As shown in FIG. 6 to FIG. 59 (except for top of FIG. 36, top of FIG. 38, top of FIG. 40, top of FIG. 48, top of FIG. 50, top of FIG. 52, FIG. 54, FIG. 56, and FIG. 58), in a system where X_{CO2} is P_{Y}/P_{X} or less, as in FIG. 4, when ΔP is smaller than (⅕)·P_{X}·X_{CO2} shown by the short dashed line in each drawing, there is a tendency that the membrane area of the inorganic separation membrane 2 becomes excessively large. Further, when ΔP is larger than (⅗)·P_{X}·X_{CO2} shown by the long dashed line in each drawing, there is a tendency that the recovery rate of methane becomes excessively small.

According to the present invention described above, the method for separating carbon dioxide is as follows. In a separation membrane system 1 provided with an inorganic separation membrane 2 that is permeated by carbon dioxide preferentially from a mixed gas containing methane and the carbon dioxide, the carbon dioxide is membrane-separated from the mixed gas such that the carbon dioxide partial pressure difference ΔP at the final outlet on the carbon dioxide non-permeation side is ⅕ or more of the carbon dioxide partial pressure on the carbon dioxide non-permeation side (P_{X}·X_{CO2}), therefore, the driving force that is a partial pressure difference of carbon dioxide between on the carbon dioxide non-permeation side and on the carbon dioxide permeation side is maintained, and further the membrane area of the inorganic separation membrane 2 to be used can be suppressed smaller, the carbon dioxide can be efficiently separated, and the cost is low.

Further, by setting ΔP to ⅗ or less of the carbon dioxide partial pressure P_{X}·X_{CO2}, the methane recovery rate is easily maintained in a relatively high state while maintaining the driving force that is a partial pressure difference (ΔP), accordingly, a technique in which the loss of methane to the permeation side is suppressed, and the recovery rate of methane is high is obtained.

In addition, the embodiment described above shows one embodiment of the present invention, the present invention is not limited to the above-described embodiment, and it goes without saying that modifications and improvements within the range in which the constitution of the present invention is provided and the object and effect of the present invention can be achieved are included in the content of the present invention. Further, there is no problem that even if other structures, shapes and the like are used as the specific structures, shapes and the like in performing the present invention within the range in which the object and effect of the present invention can be achieved. The present invention is not limited to the above-described each embodiment, and the modifications and improvements within the range in which the object of the present invention can be achieved are included in the present invention.

For example, in the above-described embodiment, as to the separation membrane system 1, the configuration shown in FIG. 1 has been described by way of an example, but an arbitrary configuration of the separation membrane system 1 in which an inorganic separation membrane 2 is provided, and carbon dioxide can be recovered at the final outlet on the carbon dioxide non-permeation side can be applied. Further, in FIG. 1, a separation membrane system 1 provided with plural stages of inorganic separation membranes 2 has been explained, but as described above, the present invention may be applied to a separation membrane system 1 provided with a single stage of inorganic separation membrane 2.

In the embodiment described above, as a separation membrane system 1 in which the method for separating carbon dioxide according to the present invention is performed, a separation membrane system 1 configured by connecting an arbitrary number of inorganic separation membranes 2 in series is mentioned by using FIG. 1, but the system may be a separation membrane system configured by including an arbitrary number of inorganic separation membranes 2 regardless of whether in parallel or in series. For example, the system may be a separation membrane system 1 or the like configured by including (n×m) number of inorganic separation membranes 2 in total, in which plural (n number) of inorganic separation membranes 2 are connected in series and m number of the connected inorganic separation membranes in series are arranged in parallel.

Further, it has been described in the embodiment described above that carbon dioxide is membrane-separated from a mixed gas such that the carbon dioxide partial pressure difference ΔP at the final outlet on the carbon dioxide non-permeation side is ⅕ or more to ⅗ or less of the carbon dioxide partial pressure on the carbon dioxide non-permeation side (P_{X}·X_{CO2}) in the separation membrane system 1, but carbon dioxide may be membrane-separated from a mixed gas such that the carbon dioxide partial pressure difference ΔP is ⅕ or more of the carbon dioxide partial pressure on the carbon dioxide non-permeation side (P_{X}·X_{CO2}), for example, carbon dioxide may be membrane-separated from a mixed gas such that the carbon dioxide partial pressure difference ΔP is slightly larger than ⅗ of the carbon dioxide partial pressure (P_{X}·X_{CO2}).

In addition, the specific structures, shapes and the like in performing the present invention may be another structure or the like within the range in which the object of the present invention can be achieved.

The present invention can be advantageously used as a measure for separating carbon dioxide from a mixed gas such as a natural gas containing carbon dioxide and methane, and the industrial applicability is extremely high.

What is claimed is:

1. A method for separating carbon dioxide, comprising:
separating carbon dioxide from a mixed gas containing methane and the carbon dioxide by a membrane separation, wherein
in a case where a carbon dioxide mole fraction at a final outlet on a carbon dioxide non-permeation side is expressed as X_{CO2}, a carbon dioxide mole fraction on a carbon dioxide permeation side corresponding to the final outlet on the carbon dioxide non-permeation side is expressed as Y_{CO2}, carbon dioxide non-permeation side pressure is expressed as P_{X}, and carbon dioxide permeation side pressure is expressed as P_{Y}, in a separation membrane system provided with an inorganic separation membrane that is permeated by the carbon dioxide preferentially from the mixed gas,
the carbon dioxide is membrane-separated from the mixed gas such that a carbon dioxide partial pressure difference ΔP expressed by the following Formula (I) at the final outlet on the carbon dioxide non-permeation side is ⅕ or more of a carbon dioxide partial pressure on the carbon dioxide non-permeation side (P_{X}·X_{CO2}).
[Mathematical Formula 1]
ΔP=P_{X}X_{CO2}−P_{Y}Y_{CO2} (I)

2. The method for separating carbon dioxide according to claim 1, wherein
the carbon dioxide is membrane-separated such that the carbon dioxide partial pressure difference ΔP is ⅗ or less of the carbon dioxide partial pressure on the carbon dioxide non-permeation side (P_{X}·X_{CO2}).

3. The method for separating carbon dioxide according to claim 1, wherein
an ideal separation factor α of the inorganic separation membrane being provided to the separation membrane system is expressed by the following Formula (II).
$$\begin{matrix}[ Mathematical Formula 2 ] & \\ \frac{20 ( {P}_{X} - {P}_{Y} ) - 4 {P}_{X} {X}_{CO 2}}{5 {P}_{Y} - 4 {P}_{X} {X}_{CO 2}} ≧ α & ( II )\end{matrix}$$

4. The method for separating carbon dioxide according to claim 1, wherein
an ideal separation factor α of the inorganic separation membrane being provided to the separation membrane system is expressed by the following Formula (III).
$$\begin{matrix}[ Mathematical Formula 3 ] & \\ \frac{10 ( {P}_{X} - {P}_{Y} ) - 6 {P}_{X} {X}_{CO 2}}{15 {P}_{Y} - 6 {P}_{X} {X}_{CO 2}} ≦ α & ( III )\end{matrix}$$

5. The method for separating carbon dioxide according to claim 1, wherein
the method is used when carbon dioxide is separated from the mixed gas such that a carbon dioxide mole fraction at the final outlet on the carbon dioxide non-permeation side X_{CO2} is a ratio (P_{Y}/P_{X}) or less of the carbon dioxide permeation side pressure P_{Y} to the carbon dioxide non-permeation side pressure P_{X}.

6. The method for separating carbon dioxide according to claim 1, wherein
carbon dioxide is separated from the mixed gas
in the range of P_{X} from 2.1 to 6.1 [MPaA],
in the range of P_{Y} from 0.10 to 0.25 [MPaA], and
in the range of X_{CO2} from 0.01 to 0.03.
